(19) United States
(12) Patent Application Publication
(10) Pub. No.: US 2025/0048369 A1
(43) Pub. Date: Feb. 6, 2025

(54) METHODS, DEVICES AND COMPUTER STORAGE MEDIA FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 18/837,446

(22) PCT Filed: Feb. 10, 2022
(86) PCT No.: PCT/CN2022/075929

§ 371 Date: Aug. 9, 2024

(51) Int. Cl. H04W 72/21; H04W 72/044; H04W 74/0833

(52) U.S. Cl. CPC H04W 72/21; H04W 72/046; H04W 74/0833

(57) ABSTRACT

Embodiments of the present disclosure relate to a method, device and computer readable storage medium of communication. The method comprises determining, at a terminal device, an uplink resource for at least one uplink transmission. The method further comprises performing, the at least one uplink transmission based on one TCI state or more than one transmission configuration indicator (TCI) state based on at least one of the following: a number of TCI states associated with the uplink resource, or a number of uplink resource sets associated with the uplink resource, each uplink resource set corresponding to a TCI state. In this way, the multi-TRP based physical uplink control channel (PUCCH) transmission is enabled.

### FIELD

Embodiments of the present disclosure generally relate to the field of telecommunication, and in particular, to methods, devices and computer storage media for communication.

### BACKGROUND

Technology of multiple input multiple output (MIMO) has been widely used in current wireless communication system, where a large number of antenna elements are used by both of a network device for communicating and a terminal device. Further, in order to improve the reliability and robustness of the communication between the network device and the terminal device, in release 16 of 3rd generation partnership project (3GPP), technology of multi-transmission and reception point (multi-TRP/MTRP) (as well as multi-panel reception) has been proposed and discussed for downlink data transmission (such as, physical downlink shared channel, PDSCH). In release 17, the multi-TRP transmission is enhanced for other physical channels (such as, physical downlink control channel, PDCCH, physical uplink shared channel, PUSCH, and physical uplink control channel, PUCCH), based on release 15/16 of 3GPP unified transmission configuration indicator (TCI)/spatial relation framework. Meanwhile, in release 17, the unified TCI framework is developed to replace/supplement release 15/16 TCI/spatial relation framework for beam indication.

So far, although some proposals about the scenario of multi-TRP have been discussed and some agreements have been reached, there are still a plurality of pending issues needed to be discussed, such that the multi-TRP transmission may be better supported.

### SUMMARY

In general, example embodiments of the present disclosure provide methods, devices and computer storage media for communication.

In a first aspect, there is provided a method of communication. The method comprises: determining, at a terminal device, an uplink resource for at least one uplink transmission. The method further comprises performing, the at least one uplink transmission based on one TCI state or more than one TCI state based on at least one of the following: a number of TCI states associated with the uplink resource, or a number of uplink resource sets associated with the uplink resource, where each uplink resource set corresponds to a TCI state.

In a second aspect, there is provided a method of communication. The method comprises: receiving, at a terminal device, a downlink control information (DCI) message indicating at least two TCI states to be used by the terminal device. The method further comprises performing at least one of the following: receiving a PDCCH based on one of the at least two TCI states; or receiving a PDSCH based on at least one of the at least two TCI states.

In a third aspect, there is provided a method of communication. The method comprises: receiving, at a terminal device, a DCI message for scheduling at least one PDSCH, the DCI message indicating at least one of: a first indication indicating a number of TCI for the at least one PDSCH; a second indication indicating one of multiple TCI states for the at least one PDSCH, the multiple TCI states being applied for at least one downlink channel; or a third indication indicating a TCI order for the at least one PDSCH. The method further comprises receiving the at least one PDSCH based on the DCI.

In a fourth aspect, there is provided a method of communication. The method comprises: receiving, at a terminal device, from a network device, a second message indicating at least one mapping, each mapping indicating a correspondence between a TCI codepoint and at least one TCI state. The method further comprises applying the at least one TCI state indicated by the second message after an application timing if the at least one TCI state satisfies an application condition.

In a fifth aspect, there is provided a method of communication. The method comprises: determining, at a network device, an uplink resource for at least one uplink transmission. The method further comprises receiving, from a terminal device, the uplink transmission based on one TCI state or more than one TCI state based on at least one of the following: a number of TCI states associated with the uplink resource, or a number of uplink resource sets associated with the uplink resource, each of the uplink resource set corresponding to a TCI state.

In a sixth aspect, there is provided a method of communication. The method comprises: transmitting, at a network device and to a terminal device, a DCI message indicating at least two TCI states to be used by the terminal device. The method further comprises performing at least one of the following: transmitting a PDCCH based on one of the at least two TCI states; or transmitting a PDSCH based on at least one of the at least two TCI states.

In a seventh aspect, there is provided a method of communication. The method comprises: transmitting, at network device and to a terminal device, a DCI message for scheduling at least one PDSCH, the DCI message indicating at least one of: a first indication indicating a number of TCI for the at least one PDSCH; a second indication indicating one of multiple TCI states for the at least one PDSCH, the multiple TCI states being applied for at least one downlink channel; or a third indication indicating a TCI order for the at least one PDSCH. The method further comprises transmitting, to the terminal device, the at least one PDSCH based on the DCI.

In an eighth aspect, there is provided a method of communication. The method comprises: transmitting, at a network device and to a terminal device, a second message indicating at least one mapping, each mapping indicating a correspondence between a TCI codepoint and at least one TCI state. The method further comprises applying the at least one TCI state indicated by the second message after an application timing if the TCI state satisfies an application condition.

In a ninth aspect, there is provided terminal device. The terminal device comprises circuitry configured to perform the method according to the above first aspect of the present disclosure.

In a tenth aspect, there is provided terminal device. The terminal device comprises circuitry configured to perform the method according to the above second aspect of the present disclosure.

In a eleventh aspect, there is provided terminal device. The terminal device comprises circuitry configured to perform the method according to the above third aspect of the present disclosure.

In a twelfth aspect, there is provided terminal device. The terminal device comprises circuitry configured to perform the method according to the above fourth aspect of the present disclosure.

In a thirteenth aspect, there is provided network device. The network device comprises circuitry configured to perform the method according to the above fifth aspect of the present disclosure.

In a fourteenth aspect, there is provided network device. The network device comprises circuitry configured to perform the method according to the above sixth aspect of the present disclosure.

In a fifteenth aspect, there is provided network device. The network device comprises circuitry configured to perform the method according to the above seventh aspect of the present disclosure.

In a sixteen aspect, there is provided network device. The network device comprises circuitry configured to perform the method according to the above eighth aspect of the present disclosure.

In a seventeenth aspect, there is provided a computer readable medium having instructions stored thereon. The instructions, when executed on at least one processor, causing the at least one processor to perform the method according to any of the above first to eighth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A to 1C illustrate example communication networks in which embodiments of the present disclosure can be implemented;

FIG. 2 a signaling flow for communication according to some example embodiments of the present disclosure;

FIG. 3 illustrates an example applying timing;

FIG. 4A illustrates an example scenario in which embodiments of the present disclosure can be implemented;

FIG. 4B illustrates an example applying timing;

FIG. 5 illustrates a flowchart of an example method performed by a terminal device in accordance with some embodiments of the present disclosure;

FIG. 6 illustrates a flowchart of an example method performed by a terminal device in accordance with some embodiments of the present disclosure;

FIG. 7 illustrates a flowchart of an example method performed by a terminal device in accordance with some embodiments of the present disclosure;

FIG. 8 illustrates a flowchart of an example method performed by a terminal device in accordance with some embodiments of the present disclosure;

FIG. 9 illustrates a flowchart of an example method performed by a network device in accordance with some embodiments of the present disclosure;

FIG. 10 illustrates a flowchart of an example method performed by a network device in accordance with some embodiments of the present disclosure;

FIG. 11 illustrates a flowchart of an example method performed by a network device in accordance with some embodiments of the present disclosure;

FIG. 12 illustrates a flowchart of an example method performed by a network device in accordance with some embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a statellite network device, an aircraft network device, and the like. For the purpose of discussion, in the following, some example embodiments will be described with reference to eNB as examples of the network device.

As used herein, the term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols cither currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

A wireless communication network comprises at least one network device and at least one terminal device. Further, the network device and the terminal device may communicate with each other via uplink transmission (such as, PUSCH and PUCCH) or downlink transmission (such as, PDSCH and PDCCH).

As discussed previously, in the release 16 of 3GPP, the technology of multi-TRP has been proposed and discussed mainly for downlink data transmission (such as, PDSCH). For example, in 3GPP release 16, it is proposed that a multi-TRP based PDSCH may be implemented through ultra-reliable low latency communication (URLLC) FDMed scheme or URLLC TDMed scheme.

In release 17, enhancements on the support for multi-TRP deployment have been discussed. For example, it has been proposed to identify and specify features to improve reliability and robustness for physical channels (such as, PDCCH, PUSCH, PUCCH) other than PDSCH using multi-TRP and/or multi-panel, based on release 15/16 of 3GPP TCI/spatial relation framework.

Different from the solution of multi-TRP based PDSCH proposed during release 16, a multi-TRP based PUCCH proposed during release 17 is proposed to be implemented two spatial relations. Specifically, one PUCCH resource is activated with two spatial relations and/or associated with two sets of power control parameters (including path loss reference signals, PL-RS, ID in each set). Further, for inter-slot repetition, number of slots is configured for the PUCCH resource, while for intra-slot repetition, the PUCCH resource is repeated for 2 consecutive sub-slots in a slot.

In addition, a concept of unified TCI has been introduced. Specifically, an unified TCI state indicated in a DCI is to indicate (update) TCI state for future transmission, and the TCI state is applied after an application timing. That is, the unified TCI state cannot be used to switch the current single-TRP based transmission to a multi-TRP based transmission.

In a nutshell, so far, schemes for different channels (such as, PDSCH PDCCH, PUSCH, PUCCH) are discussed separately and further the unified TCI framework is also discussed separately with the TCI state schemes discussed during releases 15 and 16. In this event, the multi-TRP based transmission cannot be well supported.

In the following release 18, more discussions are proposed to be discussed for the unified TCI framework. According to some of the embodiments of the present disclosure, unified TCI-based procedures for configuring/activating beam/TCI state/channel resource may be improved.

In this present disclosure, some terms may refer to same or similar physical meaning and may be used interchangeably. Some exemplary examples are listed as below.
The terms “old TCI state”, “previously indicated TCI state”, “active TCI state”, “activated TCI state”, “applied TCI state” “currently-applied TCI state” and “current TCI state” can be used interchangeably;
The terms “new TCI state”, “indicated TCI state”, “TCI state to be applied” and “TCI state to be used” can be used interchangeably;
The terms “common beam”, “common beam update/indicate/indication”, “unified TCI state”, “unified TCI state update/indicate/indication”, “beam indication”, “joint TCI state”, “TCI state for downlink and uplink”, “TCI state for downlink”, “downlink TCI state”, “TCI state for downlink only”, “TCI state for uplink”, “TCI state for uplink only”, “uplink TCI state”, “separate TCI state”, “separate DL/UL TCI state”, “TCI state(s) indication”, “TCI_state_r17”, “tci_Stateld_r17”, “TCI_state_r17 indicating a unified TCI state”, “TCI state shared/applied for all or subset of CORESETs and UE-dedicated reception on PDSCH”, “Rel-17 TCI state”, “TCI state with tci_Stateld_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably.
The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship”, “QCL configuration” and “spatial relation” can be used interchangeably;
The terms “transmission occasion”, “transmission”, “repetition”, “reception”, “reception occasion”,, “monitoring occasion”, “transmission occasion” and “candidate” can be used interchangeably.
The terms “DCI” and “DCI format” can be used interchangeably.
The terms “time threshold”, “threshold”, “application timing”, “beam application timing” and “timing” can be used interchangeably.
The terms “applied”, “activated”, “indicated” and “taken effect” can be used interchangeably.
The terms “acknowledgement”, “positive acknowledgement”, “ACK”, “Hybrid automatic repeat request acknowledgement”, “HARQ-ACK”, “negative acknowledgement”, “NACK”, “NAK”, “ACK/NACK” and “ACK/NAK” can be used interchangeably.
The terms “CORESET (sub)group”, “(sub)set of CORESETs”, “(sub)set of TCI states”, “(sub)set of unified TCI states”, “(sub)set of downlink (unified) TCI states” and “(sub)set of joint (unified) TCI states” may be used interchangeably.
The terms “(sub)set of PUCCHs”, “(sub)set of TCI states”, “(sub)set of unified TCI states”, “(sub)set of uplink (unified) TCI states” and “(sub)set of joint (unified) TCI states” may be used interchangeably.
The terms “single TRP”, “single TCI state”, “single TCI”, “S-TCI”, “single CORESET”, “single control resource set pool”, “S-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably; and.
The terms “pool”, “set”, “subset”, “group” and “subgroup” can be used interchangeably.

As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Generally speaking, one panel refers to one or more antenna elements deployed at a terminal device or a network device. In this regard, the terms (and their equivalent expressions) “panel”, “panel type”, “antenna element(s)”, “antenna array(s)”, “transmission reception point(s)”, “TRPs” can be used interchangeably.

In the following, DCI_t may be used to describe the DCI to indicate TCI state for downlink and uplink or to indicate at least one of TCI state for downlink and TCI state for uplink indication. In the following, the terms “DCI”, “PDCCH”, “DCI_t”, “DCI for TCI state for downlink and uplink indication”, “DCI for TCI state for downlink indication”, “DCI for TCI state for uplink indication”, “DCI for TCI state for downlink and TCI state for uplink indication”, “PDCCH for TCI state for downlink and uplink indication”, “PDCCH for TCI state for uplink indication”, “PDCCH for TCI state for downlink and TCI state for uplink indication”, “DCI for TCI state indication” and “PDCCH for TCI state indication” can be used interchangeably.

### Example Environment

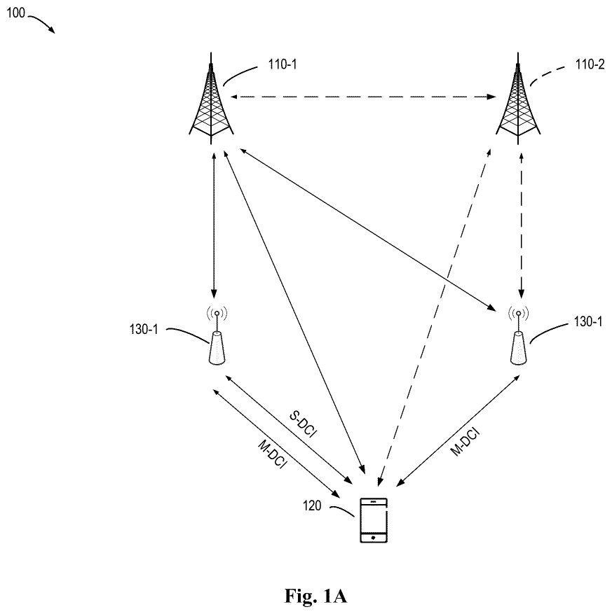

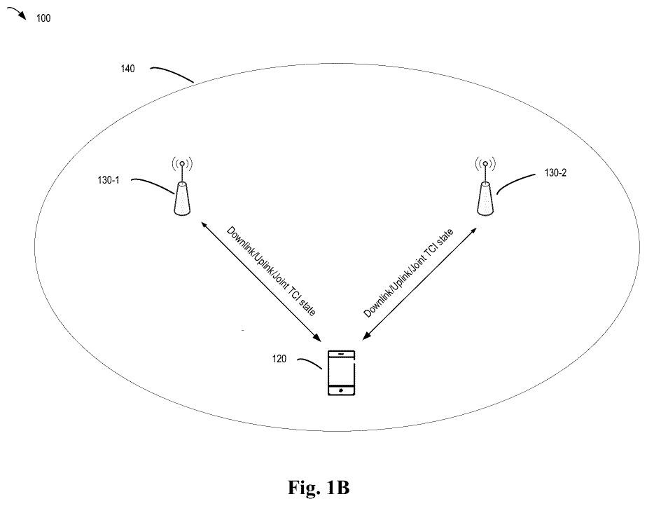

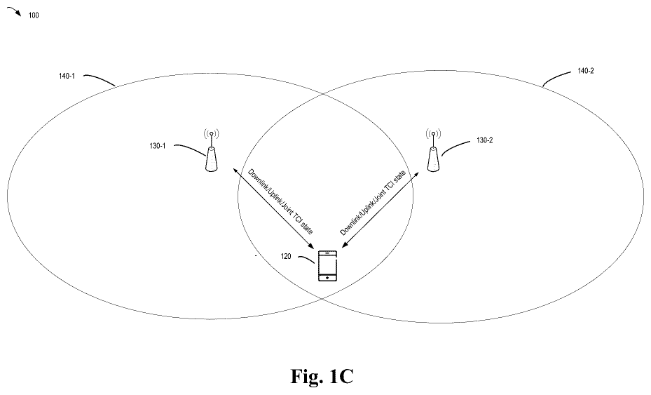

FIG. 1A illustrates an example communication network 100 in which embodiments of the present disclosure can be implemented. The communication network 100 includes a network device 110-1 and an optionally network device 110-2 (collectively or individually referred to as network devices 110). The network device 110 can provide services to a terminal device 120. For purpose of discussion, the network device 110-1 is referred to as the first network device 110-1, and the network device 110-2 is referred to as the second network device 110-2. Further, the first network device 101-1 and the second network device 110-1 can communicate with each other.

In the environment 100, a link from the network devices 110 (such as, a first network device 110-1 or the second network device 110-2) to the terminal device 120 is referred to as a downlink, while a link from the terminal device 120 to the network devices 110 (such as, a first network device 110-1 or the second network device 110-2) is referred to as an uplink. In downlink, the first network device 110-1 or the second network device 110-2 is a transmitting (TX) device (or a transmitter) and the terminal device 120 is a receiving (RX) device (or a receiver). In uplink, the terminal device 120 is a transmitting TX device (or a transmitter) and the first network device 110-1 or the second network device 110-2 is a RX device (or a receiver).

In some embodiments, the network device(s) 110 and the terminal device 120 may communicate with direct links/channels.

Further, in the specific example of FIG. 1A, a multi-TRP transmission also is supported. As illustrated in FIG. 1A, the terminal device 120 may communicate with two TRPs, i.e., the TRPs 130-1 and 130-2 (collectively or individually referred to as TRP 130). For purpose of discussion, the TRP 130-1 is referred to as the first TRP 130-1, and the TRP 130-2 is referred to as the second TRP 130-2.

Further, both a single TRP transmission mode and multi-TRP transmission mode are supported by the specific example of FIG. 1A. Specifically, in case of the single TRP mode, the terminal device 120 communicates with the network via the first TRP 130-1 or the second TRP 130-2. Alternatively, in case of the multi-TRP mode, the terminal device 120 communicates with the network via both of the first TRP 130-1 and the second TRP 130-2.

In addition, in order to support multi-TRP and/or multi-panel, the network device 110 may be equipped with one or more TRPs/panels. For example, the network device 110 may be coupled with multiple TRPs/panels in different geographical locations to achieve better coverage. In one specific example embodiment, the first network device 110-1 is equipped with the first TRP/panel 130-1 and the second TRP/panel 130-2. Alternatively, in another specific example embodiment, the first network device 110-1 and the second network device 110-2 are equipped with the first TRP/panel 130-1 and the second TRP/panel 130-2, respectively.

In some embodiments, the TRPs 130 may be explicitly associated with different higher-layer configured identities. For example, a higher-layer configured identity can be associated with a CORESET, a group of CORESETs, an RS, a set of RS, a TCI state or a group/set of TCI states. For example, the higher-layer configured identity may be used to differentiate between transmissions between different TRPs and the terminal device 120. In some embodiments, when the terminal device 120 receives two DCI messages from two CORESETs which are associated with different higher-layer configured identities, the two DCI messages are indicated from different TRPs 130.

Alternatively, the TRPs 130 may be implicitly identified by a dedicated configuration to the physical channels or signals. For example, a dedicated CORESET, a RS, and a TCI state, which are associated with a TRP 130, is used to identify a transmission from a different TRP 130 to the terminal device 120. In some embodiments, when the terminal device 120 receives a DCI message from a dedicated CORESET, the DCI message is indicated from the associated TRP dedicated by the corresponding CORESET.

In some embodiments, the network device 110 may configure a plurality of control resource sets (CORESETs) to the terminal device 120.

Additionally, the plurality of CORESETs may be divided into different groups/subset/pools. In one specific example embodiment, the first TRP 130-1 and the second TRP 130-2 are associated with different CORESET groups. For example, the first TRP 130-1 is associated with a first CORESET group while the second TRP 130-2 is associated with a second CORESET group.

According, other resources (such as, uplink resources, reference signal (RS) resource) may also be divided into different groups/subset/pools. In one specific example embodiment, the first TRP 130-1 and the second TRP 130-2 are associated with different resources sets. For example, the first TRP 130-1 is associated with a first uplink resource set (such as, a first PUCCH resource set)/a first RS set, while the second TRP 130-2 is associated with a second uplink resource set (such as, a second PUCCH resource set)/a second RS set. In some embodiments, the RS may be at least one of demodulation reference signal (DMRS), channel state information-reference signal (CSI-RS), sounding reference signal (SRS), phase tracking reference signal (PTRS) and fine time and frequency tracking reference signal (TRS).

In some embodiments, a CORESET may consist of N_{RB}^{CORESET} resource blocks (RBs) in the frequency domain and N_{symb}^{CORSET} ε {1,2,3} symbols in the time domain. In some embodiments, a control-channel element (CCE) consists of 6 resource-element groups (REGs) where a REG equals to one RB during one orthogonal frequency-division multiplexing (OFDM) symbol. In some embodiments, REGs within a CORESET are numbered in increasing order in a time-first manner, starting with 0 for the first OFDM symbol and the lowest-numbered RB in the CORESET.

In some embodiments, one CORESET may be associated with one or more search space sets. One search space set may include or may be associated with one or more PDCCH candidates. In some embodiments, PDCCH monitoring periodicity and/or slot offset and/or symbol index within a slot can be configured per search space set. In some embodiments, one PDCCH candidate may be associated with or may correspond to a search space.

In some embodiments, a procedure may be defined for determining PDCCH candidates for the terminal device 120. That is, determining the CCE index(es) for each of a plurality of PDCCH candidates that is potentially to be used for PDCCH transmission between the network device 110 and the terminal device 120. With the CCE index for PDCCH candidates determined, the terminal device 120 can perform blind detection on these PDCCH candidates. Once PDCCH transmission is detected or received on a PDCCH candidate, the terminal device 120 may decode it to obtain information such as DCI.

In some embodiments, the terminal device 120 may assume that aDM-RS antenna port associated with PDCCH reception(s) in the CORESET is quasi co-located (QCLed) with the one or more RS configured by a TCI state, where the TCI state is indicated for the CORESET, if any.

In some embodiments, the terminal device 120 may assume that a DM-RS antenna port associated with PDCCH reception(s) in the CORESET is quasi co-located (QCLed) with a synchronization signal/physical broadcast channel (SS/PBCH) block the terminal device 120 identified during a most recent random access procedure not initiated by a PDCCH order that triggers a contention-free random access procedure, if no medium access control (MAC) control element (CE) activation command indicating a TCI state for the CORESET is received after the most recent random access procedure the one or more RSs configured by a TCI state, where the TCI state is indicated for the CORESET, if any.

Further, the unified TCI framework is supported in the communication network 100. In some embodiments, the network device 110 may pre-configure a plurality of TCI states for the terminal device 120 via such as a radio resource control (RRC) signalling. Next, the multi-TRP/single TRP transmission may be scheduled by either a single DCI message or multiple DCI message (i.e., multi-DCI/M-DCI). Specifically, one or more pre-configured TCI states may be indicated by the single/multiple DCI messages.

As illustrated in FIG. 1A, when a single DCI mode is applied, the terminal device 120 receives a single DCI message from the first TRP 130-1. It should be understood that the single DCI message also may be received from the second TRP 130-2. Alternatively, when a multi-DCI mode is applied, the terminal device 120 receives two DCI messages from the first TRP 130-1 and the second TRP 130-2, respectively. By applying the indicated TCI states, the first TRP 130-1 and the second TRP 130-2 may be selectable activated and a directional transmission is achieved.

In some embodiments, the indicated TCI states may be any of below: joint downlink/uplink TCI state (i.e., joint DL/UL TCI state) or downlink TCI state and/or uplink TCI state. In some embodiments, a joint DL/UL TCI state may be a TCI state for both downlink and uplink. In some embodiments, a downlink TCI state may be a TCI state for downlink. In some embodiments, an uplink TCI state may be a TCI state for uplink.

For the purpose of discussion, parameters M and N are defined as below:
M: refers to a number of indicated/applied TCI states for downlink transmission supported by the terminal device 120; additionally, in some embodiments, M may be one of {0, 1, 2, 3, 4}; and
N: refers to a number of indicated/applied TCI states for uplink transmission supported the terminal device 120; additionally, in some embodiments some embodiments, M may be one of {0, 1, 2, 3, 4}.

Some example scenarios of different values of M and/or N are listed as below:
For M=1:
   DL TCI: The source reference signal(s) (analogous to Rel.15, two, if qcl_Type2 is configured in addition to qcl_Type1) in the DL TCI provides QCL information at least for UE-dedicated reception on PDSCH and all of CORESETs in a component carrier (CC).
For N=1:
   UL TCI: The source reference signal in the UL TCI provides a reference for determining UL TX spatial filter at least for dynamic-grant/configured-grant based PUSCH and all of dedicated PUCCH resources in a CC.
For M=N=1:
   Joint DL/UL TCI: A TCI refers to at least a common source reference RS used for determining both the DL QCL information and the UL TX spatial filter.
   Separate DL/UL TCI: The DL TCI and UL TCI are distinct (therefore, separate).
For M>1:
   DL TCI: Each of the M source reference signals (or 2M, if qcl_Type2 is configured in addition to qcl_Type1) in the M DL TCIs provides QCL information at least for one of the M beam pair links for UE-dedicated receptions on PDSCH and/or subset of CORESETs in a CC.
For N>1:
   UL TCI: Each of the N source reference signals in the N UL TCIs provide a reference for determining UL TX spatial filter at least for one of the N beam pair links associated with dynamic-grant(s)/configured-grant(s) based PUSCH, and/or subset of dedicated PUCCH resources in a CC.
For M>1 and/or N>1:
   Joint DL/UL TCI: A TCI refers to at least a common source reference RS used for determining both the DL QCL information and the UL TX spatial filter. In this case, M=N.
Separate DL/UL TCI: The M DL TCIs and N UL TCIs are distinct (therefore, separate).

In some embodiments, the terminal device 120 may be configured or indicated with M activated unified TCI states. In some embodiments, the unified TCI states may be TCI states for downlink or TCI states for downlink and uplink, where, M is positive integer for example M may be one of {1, 2, 3, 4}.

In some embodiments, the terminal device 120 may be configured or indicated with N activated unified TCI states. In some embodiments, the unified TCI states may be TCI states for uplink or joint TCI states for downlink and uplink, where, N is positive integer, for example, N may be one of {1, 2, 3, 4}.

The network device 110 may communicate data and/or downlink control information and/or RS to the terminal device 120 via a plurality of beams (also referred to as “DL beams”). The terminal device 120 may also communicate data and/or uplink control information and/or RS to the network device 110 via a plurality of beams (also referred to as “UL beams”). In 3GPP specifications for NR, a beam is also defined and indicated by parameters of a TCI. For example, there may be a TCI field in DCI. A value of the TCI field may be referred to as a “TCI codepoint”. A TCI codepoint may indicate one or more TCI states. Each TCI state contains parameters for configuring a quasi co-location (QCL) relationship between one or two DL and/or UL reference signals and the DMRS ports of the PDSCH, the DMRS ports of PDCCH, the DMRS ports of PUSCH, the DMRS ports of PUCCH, the SRS ports of a SRS resource or the CSI-RS ports of a CSI-RS resource.

In some embodiments, there may be an application timing for beam indication or TCI state(s) indication.

In some embodiments, the application timing may be the first slot or the first subslot that is at least Y symbols after the last symbol of the acknowledge of the beam indication or TCI state indication. In one specific example embodiment, Y may be an integer, for example 1<=Y<=336. In another specific example embodiment, Y may be an integer, for example, Y may be one of {7, 14, 28, 224, 336}.

In some embodiments, a slot may include 12 or 14 (OFDM) symbols. In some embodiments, subslot may include S symbols, where S is an integer, for example, 1<=S<=14. In one specific example embodiment, S may be one of {2, 4, 7}. In some embodiments, the TCI state is indicated in a DCI in a PDCCH. Specifically, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the TCI state(s) indication may be the acknowledge of the PDSCH scheduled by the DCI, for example, when the DCI schedules the PDSCH. In some embodiments, the acknowledge of the TCI state(s) indication may be the acknowledge of the DCI. In some embodiments when the DCI doesn't schedule a PDSCH. For example, the application timing may also be represented as beam application timing.

In some embodiments, the application timing may be the first slot or first subslot that is after slot n+3Nₛₗₒₜ^{subframe,μ}. where u may be the SCS configuration for the PUCCH. For example, μ=0 refers to subcarrier spacing 15 kHz; μ=1 refers to subcarrier spacing 30 kHz; μ=2 refers to subcarrier spacing 60 kHz; μ=3 refers to subcarrier spacing 120 kHz; μ=4 refers to subcarrier spacing 240 kHz; μ=5 refers to subcarrier spacing 480 kHz; μ=6 refers to subcarrier spacing 960 kHz; and

where Nₛₗₒₜ^{subframe,μ} slot maybe number of slots per subframe for subcarrier spacing configuration μ. For example, the value of Nₛₗₒₜ^{subframe,μ} may be one of {1, 2, 4, 8, 16, 32, 64}. In one specific example embodiments, subframe, Nₛₗₒₜ^{subframe,μ}=1, when μ0; Nₛₗₒₜ^{subframe,μ}=2, when μ=1; Nₛₗₒₜ ^{subframe,μ}=4, when μ=2; Nₛₗₒₜ ^{subframe,μ}=8, when μ=3; Nₛₗₒₜ ^{subframe,μ}=16, when μ=4; Nₛₗₒₜ ^{subframe,μ}=32, when μ=5; Nₛₗₒₜ ^{subframe,μ}=64, when μ=6.

In some embodiments, slot n may be a slot on which the terminal device 120 may transmit a PUCCH with HARQ-ACK information, wherein the HARQ-ACK information may correspond to an activation command. In one specific example embodiment, the activation command may be carried in a PDSCH. In another specific example embodiment, the activation command may be a MAC CE message. In a further specific example, the activation command may be used to active at least one TCI state. In a further specific example, the activation command may be used to indicate mapping between at least one TCI state and at least one codepoint, wherein the codepoint may be in DCI field ‘Transmission Configuration Indication’.

In some embodiments, the value of n may be a non-negative integer. For example, 0≤n≤Nₛₗₒₜ^{subframe,μ}−1. In one specific example embodiment, the application timing may also be represented as beam application timing. In another specific example embodiment, the application timing may also be represented as application timing for MAC CE message. In a further specific example, the application timing may also be represented as MAC CE activation timing.

In some embodiments, a DCI (for example, DCI format 1_1/1_2 with and without downlink assignment) may be used for TCI state(s) indication. In some embodiments, a DCI with downlink scheduling or PDSCH scheduling may indicate at least one TCI state, and HARQ or ACK and/or NACK for the PDSCH or downlink scheduling can be used to indicate acknowledgement of the at least one TCI state indication. Further, after the application timing, the indicated TCI state may be applied. For example, be applied to PDSCH and/or PDCCH and/or PUSCH and/or PUCCH and/or downlink RS and/or uplink

RS.

In some embodiments, the terminal device 120 may receive or detect a DCI (for example, represented as “DCI_t”) in a PDCCH, and the DCI may indicate a TCI state for downlink and uplink or a TCI state for downlink or a TCI state for uplink or a pair of a TCI state for downlink and a TCI state for uplink.

In some embodiments, the indicated TCI state for downlink and uplink or the indicated TCI state for downlink or the indicated TCI state for uplink or the pair of indicated TCI state for downlink and TCI state for uplink may be applied to PDSCH and/or CORESET and/or PUSCH and/or PUCCH and/or uplink RS and/or downlink RS after the application timing.

In one specific example embodiment, when a TCI state for downlink and uplink is indicated in the DCI, the TCI state for downlink and uplink may be applied to PDSCH and/or CORESET and/or PUSCH and/or PUCCH and/or uplink RS and/or downlink RS after the application timing. In another specific example embodiment, when a TCI state for downlink is indicated in the DCI, the TCI state for downlink may be applied to PDSCH and/or CORESET and/or downlink RS after the application timing. In a further specific example embodiment, when a TCI state for uplink is indicated in the DCI, the TCI state for uplink may be applied to PUSCH and/or PUCCH and/or uplink RS after the application timing. In a further specific example embodiment, when a pair of a TCI state for downlink and a TCI state for uplink is indicated in the DCI, the TCI state for downlink may be applied to PDSCH and/or CORESET and/or downlink RS after the application timing, and the TCI state for uplink may be applied to PUSCH and/or PUCCH and/or uplink RS after the application timing.

In some embodiments, the terminal device 120 may receive an indication to indicate a TCI state for downlink (or a beam or a set of QCL parameters), and the source RS(s) in the TCI state provides QCL information at least for reception on PDSCH and all of CORESETs in a CC. In one specific example embodiment, the PDSCH is dedicated or UE-specific.

In some embodiments, the terminal device 120 may receive an indication to indicate a TCI state for uplink (or a beam or a spatial relation), and the source RS(s) in the TCI state provides a reference for determining uplink transmission spatial filter at least for dynamic grant or configured grant based PUSCH, and all of PUCCH resources in a CC. For example, the PUCCH is dedicated or UE-specific.

In some embodiments, the terminal device 120 may receive an indication to indicate a TCI state for downlink and uplink (or a beam or a set of QCL parameters), and the TCI state refers to at least a common source RS used for determining both the downlink QCL information and the uplink transmission spatial filter.

In some embodiments, the terminal device 120 may receive an indication to indicate a TCI state for downlink (or a beam or a set of QCL parameters) and a TCI state for uplink (or a beam or a spatial relation), and the source RS(s) in the TCI state for downlink provides QCL information at least for reception on PDSCH and all of CORESETs in a CC, and the source RS(s) in the TCI state for uplink provides a reference for determining uplink transmission spatial filter at least for dynamic grant or configured grant based PUSCH, and all of PUCCH resources in a CC. In one specific example embodiment, the PUCCH is dedicated or UE-specific. In another specific example embodiment, the PDSCH is dedicated or UE-specific.

In some embodiments, the terminal device 120 may be configured with more than one (for example, represented as M, M is positive integer. For example, M may be one of {1, 2, 3, 4}) TCI states for downlink, and/or the terminal device 120 may receive an indication to indicate one of the M TCI states, and the source RS(s) in the one of the M TCI states or in the indicated one TCI state provides QCL information at least for reception on PDSCH and/or a subset of CORESETs in a CC. In one specific example embodiment, the PDSCH is dedicated or UE-specific.

In some embodiments, the terminal device 120 may be configured with more than one (For example, represented as N, N is positive integer. For example, N may be one of {1, 2, 3, 4}) TCI states for uplink, and/or the terminal device 120 may receive an indication to indicate one of the N TCI states, and the source RS(s) in the one of the N TCI states or in the indicated one TCI state provides a reference for determining uplink transmission spatial filter at least for dynamic grant or configured grant based PUSCH, and/or a subset of PUCCH resources in a CC. In one specific example embodiment, the PUCCH is dedicated or UE-specific.

In some embodiments, the terminal device 120 may be configured with more than one (For example, represented as M, M is positive integer. For example, M may be one of {1, 2, 3, 4}) TCI states for downlink and uplink, and/or receive an indication to indicate one from the M TCI states for downlink and uplink, and each one of the M TCI states or the indicated one TCI state refers to at least a common source reference signal used for determining both the downlink QCL information and the uplink transmission spatial filter.

In some embodiments, the terminal device 120 may be configured with more than one (For example, represented as M, M is positive integer. For example, M may be one of {1, 2, 3, 4}) TCI states for downlink and the terminal device 120 may be configured with more than one (For example, represented as N, N is positive integer. For example, N may be one of {1, 2, 3, 4}) TCI states for uplink, and/or the terminal device 120 may receive an indication to indicate one from the M TCI states for downlink and one from the N TCI states for uplink, and the source RS(s) in each one of the M TCI states for downlink or the indicated one TCI state for downlink provides QCL information at least for reception on PDSCH and/or a subset of CORESETs in a CC, and the source RS(s) in each one of the N TCI states for uplink or in the indicated one TCI state for uplink provides a reference for determining uplink transmission spatial filter at least for dynamic grant or configured grant based PUSCH, and/or a subset of PUCCH resources in a CC. In one specific example embodiment, the PUCCH is dedicated or UE-specific. In another specific example embodiment, the PDSCH is dedicated or UE-specific.

In the following, DCI_t may be used to describe the DCI to indicate TCI state for downlink and uplink or to indicate at least one of TCI state for downlink and TCI state for uplink indication. In the following, the terms “DCI”, “PDCCH”, “DCI_t”, “DCI for TCI state for downlink and uplink indication”, “DCI for TCI state for downlink indication”, “DCI for TCI state for uplink indication”, “DCI for TCI state for downlink and TCI state for uplink indication”, “PDCCH for TCI state for downlink and uplink indication”, “PDCCH for TCI state for uplink indication”, “PDCCH for TCI state for downlink and TCI state for uplink indication”, “DCI for TCI state indication” and “PDCCH for TCI state indication” can be used interchangeably.

In some embodiments, a DCI may be used for indicating a TCI state for downlink and uplink or for indicating at least one of a TCI state for downlink and a TCI state for uplink. Further, the DCI may schedule a PDSCH (for example, DCI format 1_1 and format 1_2). For example, the DCI may be DCI_t. In some embodiments, the HARQ of the PDSCH scheduled by the DCI can be used as an ACK for the DCI.

In some embodiments, a DCI may be used for indicating a TCI state for downlink and uplink or for indicating at least one of a TCI state for downlink and a TCI state for uplink. Further, the DCI may not schedule a PDSCH (for example, DCI format 1_1 and format 1_2). For example, the DCI may be DCI_t. In some embodiments, a HARQ of the DCI may be introduced to indicate whether the DCI or the TCI state indication is successful.

In some embodiments, if decoding of DCI_t or decoding of the PDSCH scheduled by DCI_t is ACK, the indicated TCI state may be applied for PDSCH and/or all or subset of CORESETs after the application timing.

In some embodiments, HARQ mechanism of semi persistent scheduling (SPS) PDSCH release can be reused for HARQ of DCI_t, and there is no PDSCH scheduling in the DCI_t.

In some embodiments, a DCI (for example, DCI_t) may be used for indicating one or more TCI states. For example, the one or more TCI states are for downlink and uplink or for at least one of a TCI state for downlink and a TCI state for uplink. Further, the DCI may not schedule a PDSCH (for example, DCI format 1_1 and format 1_2).

In some embodiments, upon a successful reception/decoding of the DCI, the terminal device 120 may report an ACK. In some embodiments, upon a failed reception/decoding of the DCI, the terminal device 120 may report a NACK. For example, the ACK and/or NACK may be reported in a PUCCH or a PUSCH.

In some embodiments, the terminal device 120 may be configured with a type of HARQ codebook. For example, the type may be at least one of Type 1 (for example, semi-static), Type 2 (for example, dynamic) and Type 3 (one shot feedback). Further, the type may be configured via such as, an RRC, MAC CE or DCI. In some embodiments, the DCI is received/detected in a PDCCH.

In some embodiments, for a HARQ-ACK information bit, the terminal device 120 generates a positive ACK if the terminal device 120 detects a DCI format that provides a SPS PDSCH release or a beam indication with CS-RNTI scrambled or correctly decodes a transport block, and generates a NACK if the terminal device 120 does not correctly decode the transport block. In one specific example embodiments, a HARQ-ACK information bit value of 0 represents a NACK while a HARQ-ACK information bit value of 1 represents an ACK.

In some embodiments, the terminal device 120 may be configured/indicated with a first TCI state for reception of PDSCH and/or all or a subset of CORESETs. Further, the terminal device 120 may receive or detect a first PDCCH with the first TCI state, and the PDCCH is in a first CORESET. The terminal device 120 may be indicated with a second TCI state in the DCI received or detected in the first PDCCH. In some embodiments, the DCI in the first PDCCH may schedule or may not schedule a first PDSCH or a first PUSCH.

In some embodiments, the terminal device 120 may report the decoding result or HARQ-ACK information for at least one of the DCI or the first PDCCH or the first PDSCH to the network device 110. In some embodiments, the decoding result or the HARQ-ACK information may be transmitted/reported in a PUCCH or in a second PUSCH.

In some embodiments, after the application timing, the terminal device 120 may receive PDSCH and/or all or the subset of CORESETs with the second TCI state. In one specific example embodiment, the terminal device 120 may receive a second PDCCH with the second TCI state, and the second PDCCH is in a second CORESET. In another specific example embodiment, the terminal device 120 may receive a second PDCCH with the second TCI state, and the second PDCCH is in the first CORESET.

Further, the network device(s) 110 may provide one or more serving cells and the first TRP 130-1 and the second TRP 130-2 may be included in a same serving cell or different serving cells. In other words, both an inter-cell transmission and an intra-cell transmission are supported by the specific example of FIG. 1A.

FIG. 1B shows an example scenario of the communication network 100 as shown in FIG. 1A. In the specific example of FIG. 1B, the first TRP 130-1 and the second TRP 130-2 are included in a same serving cell 140. In this event, the multi-TRP transmission is performed as an intra-cell transmission.

FIG. 1C shows another example scenario of the communication network 100 as shown in FIG. 1A. In the specific example of FIG. 1C, the first TRP 130-1 and the second TRP 130-2 are included in different serving cells 140-1 and 140-2. In this event, the multi-TRP transmission is performed as an inter-cell transmission.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices (i.e., the terminal device 120, the network device 110, the TRP 130 and the cell 140) and their connection relationships and types shown in FIGS. 1A to 1C are only for the purpose of illustration without suggesting any limitation. The communication network 100 may include any suitable numbers of devices adapted for implementing embodiments of the present disclosure.

### Example Processes

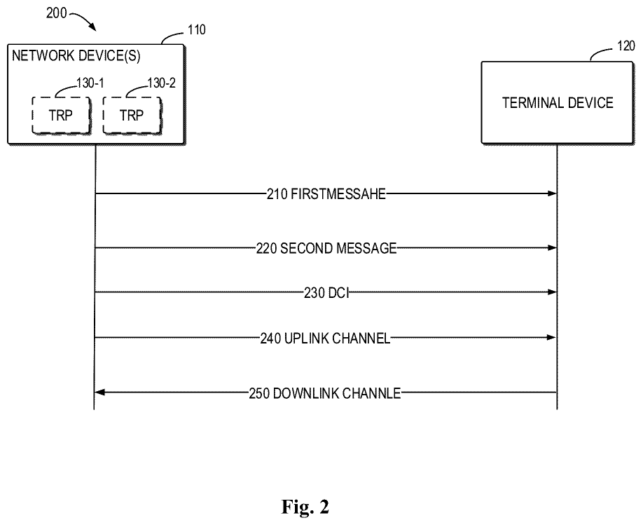

Principle and implementations of the present disclosure will be described in detail below with reference to FIG. 2, which show a signaling chart illustrating process 200 of communication according to some example embodiments of the present disclosure. For the purpose of discussion, the process 200 will be described with reference to FIGS. 1A to 1C.

The process 200 may involve the terminal device 120, the network device 110 (either or both of the first network device 110-1 or the second network device 110-2), and the TRPs 130 (including at least one of the first TRP 130-1 and the second TRP 130-2).

Additionally, the first TRP 130-1 is connected to the first network device 110-1, while the second TRP 130-2 is connected to the first network device 110-1/second network device 110-2. In addition, the first TRP 130-1 and the second TRP may be in a same serving cell and in different serving cells.

In the following text, although some embodiments of the present disclosure are described with reference to two TRPs, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Further, it is to be understood that the operations at the terminal device 120 and the network device 110 should be coordinated. In other words, the network device 110 and the terminal device 120 should have common understanding about configuration, state, parameters and so on. Such common understanding may be implemented by any suitable interactions between the network device 110 and the terminal device 120 or both the network device 110 and the terminal device 120 applying the same rule/policy. In the following, although some operations are described from a perspective of the terminal device 120, it is to be understood that the corresponding operations should be performed by the network device 110. Similarly, although some operations are described from a perspective of the network device 110, it is to be understood that the corresponding operations should be performed by the terminal device 120. Merely for brevity, some of the same or similar contents are omitted here.

In addition, in the following description, some interactions are performed among the terminal device 120 and the network device 110. It is to be understood that the interactions may be implemented either in one single signaling/message or multiple signaling/messages, including system information, RRC message, DCI message, uplink control information (UCI) message, media access control (MAC) control element (CE) and so on. The present disclosure is not limited in this regard.

Moreover, it should be understood that although feature(s)/operation(s) are discussed in specific example embodiments separately, unless clearly indicated to the contrary, these feature(s)/operation(s) described in different example embodiments may be used in any suitable combination.

### Example Processes for Configuration

Optionally, according to some embodiments of the present disclosure, the terminal device 120 and the network device 110 may communicate related configuration(s) to enable the embodiments according to the present disclosure, which will be discussed as below. During this interactive procedure, certain rules associated with the embodiments of the present disclosure may be stipulated, and the related re-defined/newly-introduced parameters/configuration may be exchanged between the terminal device 120 and the network device 110.

Reference is made to FIG. 2. As illustrated in FIG. 2, the network device 110 may transmit 210 the related configuration(s) (i.e., the first message) to the terminal device 120.

In some embodiments, the related configuration(s) may be comprised in an RRC message. In some other embodiments, the related configuration(s) may be comprised in any other suitable signalling/message(s), including but not limited to DCI message, MAC CE and so on.

Further, according to some embodiments of the present discourse, some resource configuration may be improved. In the following, some improved configuration will be discussed in detail.

### Configuration for CORESET

In some embodiments, the network device 110 transmits at least one first message (such as, RRC message(s), be referred to as a first message for brevity) to the terminal device 120, where the at least one first message indicates a plurality of CORESETs and/or a plurality of TCI states.

Optionally, a concept of CORESET group may be introduced. Specifically, there are M DL/joint TCI states (represented as T_1, T_2, . . . T_M), where M is an integer and may be one of {2, 3, 4}. Accordingly, there may be M CORESET groups (i.e., M subsets of CORESETs, represented as C_1, C_2, . . . C_M), where each CORESET group (and corresponding PDSCH) may be associated with one of the M TCI states. For example, C_1 is associated with T_1, C_2 is associated with T_2 and so on.

In view of the introduced concept of CORESET group, a CORESET may be associated with one or more CORESET group.

In one specific example embodiment, a CORESET may be configured with a parameter, wherein the parameter may be an index of the group (represented as CORESETPoolIndex), via such as, an RRC message, MAC CE message or DCI message.

In some embodiments, in case of M=2, (For example, for multi-DCI based multi-TRP) there may be two CORESET groups/subsets of CORESETs based on the configuration of CORESETPoolIndex. Specifically, group C_1 may be CORESETs without configuration of CORESETPoolIndex or CORESETs with configuration of CORESETPoolIndex with value 0, while group C_2 may be CORESETs with configuration of CORESETPoolIndex with configuration with value 1.

Below is an example of part of the configuration for CORESET.

| | |
|---|---|
| ControlResourceSet ::= | SEQUENCE { |
| ... | |
| followUnifiedTCIstate-r17 | ENUMERATED {enabled} |
| OPTIONAL -- Need R | |
| subsetIndex | INTEGER (0..M-1) (for example, may be |

conditioned on followUnifiedTCIstate-r17 to be enabled)

In this way, the configuration of CORESET may be more suitable for the multi-TRP scenario.

### Configuration for Uplink Resource

In some embodiments, the network device 110 transmits a first message (such as, a RRC message) to the terminal device 120, where the first message indicates a plurality of uplink resources (such as, PUCCH resources) and a plurality of TCI states.

Optionally, a concept of uplink resource sets (such as, PUCCH resource set) may be introduced. Specifically, there are N UL/joint TCI states (represented as T_1, T_2, . . . T_N), where N is an integer, may be one of {2, 3, 4}. Accordingly, there may be N PUCCH resource sets (e.g., N PUCCH resource sets, represented as P_1, P_2, . . . P_N), where each PUCCH resource set may be associated with one of the N TCI states. For example, P_1 is associated with T_1, P_2 is associated with T_2 and so on.

In view of the introduced concept of uplink resource sets, an uplink resource may be associated with one or more uplink resource sets.

In some embodiments, each uplink resource is associated with more than one uplink resource sets.

In one specific example embodiment, an uplink resource may be configured with a parameter, wherein the parameter may be an index of the group, via such as, an RRC message, MAC CE message or DCI message.

Alternatively, in another specific example embodiment, the parameter configured for the uplink resource may reuse a current parameter (such as, PUCCH-ResourceGroup). Below is an example of part of the configuration for uplink resource.

| | |
|---|---|
| PUCCH- [symbol] | SEQUENCE { |
| pucch- [symbol] | PUCCH-ResourceGroupId-r16, |
| [symbol] | SEQUENCE (SIZE (1..maxNrofPUCCH-ResourcesPerGroup-r16)) OF PUCCH- |
| ResourceId | |
| } | |
| PUCCH-ResourceGroupId-r16 ::= | INTEGER (0..maxNrofPUCCH-ResourceGroups-1-r16) |
| maxNrofPUCCH-ResourceGroups-r16 | INTEGER ::= 4 -- Maximum number of PUCCH resources groups |

[symbol]

indicates data missing or illegible when filed

In the above specific example embodiment, each group may be associated with one of N TCI states.

In addition, in some embodiments, there may be a configuration of association between at least one CORESET group and at least one PUCCH resource set. In one specific example, each uplink resource is associated with one or more CORESET groups, for example, the uplink resource is configured with one or more CORESETPoolIndexes.

In this way, the configuration of uplink resource may be more suitable for the multi-TRP scenario.

### Configuration for RS

According to some embodiments of the present discourse, the configuration for the

RS also may be improved.

In some embodiments, for the RS (for example, channel state information RS, CSI-RS) which is configured to share the indicated unified TCI state, there may be a configuration to indicate that the RS is associated or is based on a specific CORESET group or a specific TCI state. In one specific example embodiment, the RS may be configured with one of the following: a CORESETPoolIndex, an index of TCI state and so on.

In some embodiments, for the RS (for example, SRS) which is configured to share the indicated unified TCI state, there may be a configuration to indicate the RS is associated or is based on which uplink resource set or which one of N TCI states. In one specific example embodiment, the RS (for example, SRS) may be configured with one of the following: an index of uplink resource set, an index of TCI state and so on.

In this way, the configuration of RS may be more suitable for the multi-TRP scenario.

### Example Processes for Activation

Still refers to FIG. 2. After the above configuration procedure, the network device 110 may transmit 220 one or more second messages (such as, MAC CE message(s)) to the terminal device 120.

In some embodiments, the second message indicates at least one association, where each association indicates an association between a CORESET group and at least one TCI state.

In this way, with the second message, at least one DL/joint TCI state may be activated for respective CORESET group.

Alternatively, or in addition, in some embodiments, the second message indicates at least one association, where each of the at least one association indicates an association between an uplink resource set and at least one TCI state.

In this way, with the second message, at least one UL/joint TCI state may be activated for respective uplink resource set.

### Example Processes for Uplink Transmission

As discussed above, in case of N>1 (i.e., N uplink TCI states), each of the N source RSs in the N uplink TCI states provides a reference for determining uplink TX spatial filter at least for one of the N beam pair links associated with dynamic-grant(s)/configured-grant(s) based PUSCH, and/or subset of dedicated PUCCH resources in a CC.

In view of this, a multi-TRP based PUCCH transmission may be implemented by establishing an association between an uplink resource and more than one UL/joint TCI state (or, more than one uplink PUCCH resource set).

In one specific example embodiment, for multi-TRP based PUCCH transmission in unified TCI framework (i.e., N>1), there are N PUCCH resource sets, and each PUCCH resource set is associated with more than one of N UL/joint TCI state (or more than one PUCCH resource set).

Still refer to FIG. 2. The terminal device 120 (and the network device 110) may determine an uplink resource (such as, PUCCH resource) for at least one uplink transmission. Then, the terminal device 120 may perform 240 the at least one uplink transmission with the network device 110 accordingly. In particular, the at least one uplink transmission may be performed based on either one TCI state or more than one TCI state, based on at least one of the following:
a number of TCI states associated with the uplink resource, or
a number of uplink resource sets associated with the uplink resource, each uplink resource set corresponding to a TCI state.

In this way, for the multi-TRP based PUCCH, a dynamic switch between single TRP and multi-TRP is enabled.

In some embodiments, the terminal device 120 performs the at least one uplink transmission based on one TCI state if the uplink resource is associated with the one TCI state or one uplink resource set. Alternatively, in some embodiments, the terminal device 120 performs the at least one uplink transmission based on more than one TCI state if the uplink resource is associated with the more than one TCI state or more than one uplink resource set.

In some embodiments, one uplink resource (such as, PUCCH resource) can be associated with K uplink resource sets. In one example, 1<=K<=N. In another example, 1<=K<=2. Specifically, if the PUCCH resource is associated with one uplink resource set, transmission of the PUCCH resource is transmitted based on the single-TRP. In one specific embodiment, for DCI format 1_x, the determined PUCCH resource for HARQ-ACK feedback is transmitted based on the indicated TCI state associated with the uplink resource set.

Alternatively, if a PUCCH resource is associated with more than one uplink resource set (i.e., K>1), transmission of the PUCCH resource is transmitted based on the multi-TRP. In one specific embodiment, the PUCCH resource is associated with two uplink resource sets (i.e., a first uplink resource set and a second uplink resource set). In this specific embodiment, for DCI format 1_x, the determined PUCCH resource for HARQ-ACK feedback is transmitted based on a first indicated TCI state associated with the first uplink resource set and a second indicated TCI state associated with the second uplink resource set.

Additionally, the at least one uplink transmission also may be performed based on a repetition parameter configured for the at least one uplink transmission (for example, a repetition parameter configured in an RRC message).

In some embodiments, the terminal device 120 may be configured with two PUCCH resource sets (for example, a first PUCCH resource set and a second PUCCH resource set). Further, each PUCCH resource set may include at least one PUCCH resource. In some embodiments, there may be a TCI state (for example a TCI state for downlink and uplink or a TCI state for uplink) associated or applied to each PUCCH resource set. Further, a first TCI state may be associated or applied to the first PUCCH resource set while a second TCI state may be associated or applied to the second PUCCH resource set. In particular, the first TCI state may be different from the second TCI state.

In some embodiments, one PUCCH resource may be configured to be associated with one or two PUCCH resource sets. In some embodiments, if the PUCCH resource is associated with one PUCCH resource set, the PUCCH transmission may be based on the single-TRP. In some embodiments, if the PUCCH resource is associated with the first PUCCH resource set, the PUCCH transmission may be based on the first TCI state. Alternatively, in some other embodiments, if the PUCCH resource is associated with the second PUCCH resource set, the PUCCH transmission may be based on the second TCI state.

In some embodiments, if the PUCCH resource is associated with two PUCCH resource sets, the PUCCH transmission may be based on the multi-TRP. For example, if the PUCCH resource is associated with the first PUCCH resource set and the second PUCCH resource, the PUCCH transmission may be based on the first TCI state and the second TCI state. In some embodiments, the PUCCH transmission may include at least one transmission occasion, and each transmission occasion may be based on one of the first TCI state and the second TCI state. Alternatively, in some other embodiments, the PUCCH transmission may be based on the first TCI state and the second TCI state at the same time.

In one specific embodiment, in a DCI (for example, DCI format 1_0 or DCI format 1_1 or DCI format 1_2), there may be an indication of a PUCCH resource. In some embodiments, the PUCCH resource may be used for HARQ-ACK feedback. Alternatively, in some other embodiments, the indicated PUCCH resource may be transmitted based on the indicated/applied TCI state(s) associated with the PUCCH resource set(s).

Specifically, in some embodiments, if a repetition parameter configured for the at least one uplink transmission is larger than one, the terminal device 120 performs the uplink transmission based on the more than one TCI state with more than one transmission occasion, where each transmission occasion is associated with one of the more than one TCI state. Additionally, in some embodiments, the number of more than one transmission occasion is based on the repetition parameter.

In one specific embodiment, if a repetition number of PUCCH repetition is larger than one (for example, N_{PUCCH}^{repeat}>1), a multi-TRP based PUCCH repetition is applied (such as, through cyclic or sequential mapping of the indicated TCI states), where each PUCCH transmission occasion is associated with one TCI state.

Alternatively, in some embodiments, if a repetition parameter configured for the at least one uplink transmission is absent or equals to one, the terminal device 120 performs the uplink transmission based on the more than one TCI state. For example, the terminal device 120 performs the uplink transmission based on the more than one TCI state within one transmission occasion.

In one specific embodiment, if a repetition parameter is absent or a number of PUCCH repetition equals to one (for example, N_{PUCCH}^{repeat}=1), a simultaneous PUCCH transmission is performed based on two TCI states (for example simultaneous multi-panel uplink transmission).

In addition, in some scenarios, the terminal device 120 is supported to be configured up to two uplink TCI states. For such scenarios, in some embodiments, if the uplink resource is associated with more than two TCI states, the terminal device 120 will perform the at least one uplink transmission based on two TCI states determined from the more than two TCI states.

In some embodiments, the two TCI states are one of the following:
two TCI states with lower identifies,
two TCI states with higher identifies,
two latest-used TCI states, or
two TCI states determined either by the terminal device 120 or a network device 110.

Similarly, in some embodiments, if the uplink resource is associated with more than two TCI states, the terminal device 120 will perform the at least one uplink transmission based on two uplink resource sets determined from the more than two uplink resource sets.

In some embodiments, the two TCI states are one of the following:
two uplink resource sets with lower identifies,
two uplink resource sets with higher identifies,
two latest-used uplink resource sets, or
two uplink resource sets determined either by the terminal device 120 or a network device 110.

In addition, some transmission parameters (such as, uplink power control parameter(s)) are necessary for the uplink transmission. In some embodiments, if uplink power control parameter(s) is not associated with or included in uplink/joint TCI state, set(s) of power control parameters may be configured for the PUCCH resource. Specifically, if the PUCCH resource is associated with K uplink resource sets (where K>1 or K=2), K sets of power control parameters may be configured for the PUCCH resource.

Further, pathloss RS is also necessary for the uplink transmission. In some embodiments, if the pathloss RS is not associated with or included in uplink/joint TCI state, pathloss RS(s) may be configured for the PUCCH resource. Specifically, if the PUCCH resource is associated with K uplink resource sets (where K>1 or K=2), K pathloss RSs may be configured for the PUCCH resource.

As discussed previously, in the unified TCI framework, the TCI state(s) to be applied is indicated in the DCI message. However, in some scenarios, the terminal device 120 may need to perform an uplink transmission before receiving the DCI message. Below will discuss how to handle such scenario.

In some embodiments, the terminal device 120 performs the uplink transmission based on at least one of the following:
at least one currently-used TCI state,
TCI states associated with the uplink resource,
one or more TCI states to be used the terminal device, indicated by at least one downlink control information (DCI) message, or
at least one spatial domain filter used for a PUSCH, wherein the PUSCH is at least one of: a PUSCH scheduled by a random access response (RAR) uplink grant, a message A (MsgA) PUSCH or a PUSCH scheduled during an initial access procedure.

In some embodiments, before the terminal device 120 receives and applies a first instance of a unified TCI state indication, transmission of all PUCCH resources is performed based on the same spatial domain filter as for a PUSCH transmission scheduled by a RAR uplink grant or MsgA PUSCH.

In addition, in case that the uplink resource is associated with the more than one TCI state or more than one uplink resource set (i.e., a multi-TRP scenario), it is not ensured that all the associated TCI states are available. For example, the associated TCI state has not been indicated by the DCI message or has not been applied according to an application timing. Below will discuss how to handle such scenario.

In some embodiments, the terminal device 120 performs the uplink transmission based on more than one TCI state if at least one of the more than one TCI state associated with the uplink resource is indicated and applied after an application timing. Some example processes are described as below.

In some embodiments, if the terminal device 120 has received and applied a first instance of a unified TCI state indication, transmission of the first subset and/or the second subset of PUCCH resources may be performed based on the same spatial domain filter as for a first transmission occasion and second transmission occasion of PUSCH scheduled by a RAR UL grant or MsgA PUSCH, respectively.

Additionally, in some embodiments, if the determined PUCCH resource is associated with the first and second uplink resource sets, a multi-TRP transmission is applied for the PUCCH resource.

In some embodiments, if the terminal device 120 has received and applied a first unified TCI state indication (e.g. for the first uplink resource set) while the terminal device 120 has not received and applied a first instance of a second unified TCI state indication (e.g. for the second uplink resource set), the terminal device 120 may perform a multi-TRP PUCCH transmission with two TCI states (i.e., the first unified TCI state, a second TCI state which is replaced by the spatial domain filter as for a PUSCH transmission scheduled by a RAR UL grant or MsgA PUSCH).

Alternatively, if the terminal device 120 has received and applied a first unified TCI state indication (e.g. for the first uplink resource set) while the terminal device 120 has not received and applied a first instance of a second unified TCI state indication (e.g. for the second uplink resource set) and if the determined PUCCH resource is only associated with the first uplink resource set, the terminal device 120 may perform a single-TRP transmission for the PUCCH resource (based on the first unified TCI state). Further, if the determined PUCCH resource is only associated with the second uplink resource set, a single-TRP transmission is applied for the PUCCH resource (based on the spatial domain filter as for a PUSCH transmission scheduled by a RAR UL grant or MsgA PUSCH). In addition, if the determined PUCCH resource is associated with the first and second uplink resource sets, the terminal device 120 may perform a single-TRP transmission for the PUCCH resource (based on the first unified TCI state).

In this way, a multi-TRP based PUCCH transmission may be enabled independently from the PDSCH transmission schemes, and further a multi-DCI based multi-TRP PDSCH transmission can be jointly applied with multi-TRP based PUCCH transmission.

### Example Processes for Downlink Transmission

As discussed above, in case of M>1 (i.e., M downlink TCI states), each of the M source RSs (or 2M, if qcl_Type2 is configured in addition to qcl_Type1) in the M DL TCIs provides QCL information at least for one of the M beam pair links for UE-dedicated receptions on PDSCH and/or subset of CORESETs in a CC.

According to some embodiments of the present discourse, for the unified TCI framework, the multi-TRP based PDSCH transmission is enabled.

In some embodiments, the multi-TRP based PDSCH transmission may be implemented without introducing a concept of CORESET group. In other words, for the CORESETs which are configured to apply the indicated TCI state, there is only one CORESET group. In this event, all the CORESETs are in one CORESET group, and one of two TCI states is applied to the CORESETs.

Still refer to FIG. 2. As illustrated in FIG. 2, the network device 110 transmits 230 a DCI message to the terminal device 120, where the DCI message indicates at least two TCI states to be used by the terminal device 120. Next, the network device 110 transmits 250 a PDCCH based on the at least two TCI states. For example, the network device 110 transmits the PDCCH based on one of the following: the first TCI state of the at least two TCI states, a TCI state with lower or lowest ID, a TCI state with higher or highest ID. Additionally, the network device 110 transmits a PDSCH based on at least one of the at least two TCI states. In one example embodiment, the network device 110 transmits PDSCH based on a TCI state different from the TCI state used by the PDCCH. In another example embodiment, the network device 110 transmits PDSCH based on two TCI states.

In some embodiments, if the terminal device 120 has not received and applied a first instance of any unified TCI state indication, the terminal device 120 assumes that the corresponding DMRS antenna port of PDCCH/PDSCH is quasi co-located with the SS/PBCH block the UE identified during the initial access procedure, or the SS/PBCH block or the CSI-RS resource that the terminal device 120 identified during the random access procedure initiated by the reconfiguration with sync procedure (e.g. represented as QCLed with QCL_A in the following).

In some embodiments, prior to applying the at least two indicated TCI states, the terminal device 120 receives the PDCCH or PDSCH based on assuming that a DMRS port of the PDCCH or the PDSCH is quasi co-located with a RS) identified during an initial access procedure or an random access procedure.

Alternatively, in some embodiments, prior to applying the at least two indicated TCI states, the terminal device 120 receives the PDCCH or PDSCH based on one applied TCI state (i.e., single-TRP).

In one specific example embodiment, if the terminal device 120 has received a DCI message with a first instance of unified TCI state(s) indication while the terminal device has not applied the indicated unified TCI state(s), the terminal device 120 assumes that a DMRS port of the PDCCH or the PDSCH is quasi co-located with QCL_A (single-TRP transmission is applied for the scheduled PDSCH in the DCI) regardless of where one or two DL/joint unified TCI states are indicated and regardless of whether a single-TRP/multi-TRP transmission mode are indicated in the DCI.

Alternatively, or in addition, if the terminal device 120 has received a DCI with a first instance of unified TCI state(s) indication while the terminal device has not applied the indicated unified TCI state(s), the terminal device 120 performs a single-TRP transmission is applied for PDSCH scheduled by a DCI before the UE applies the indicated unified TCI state(s).

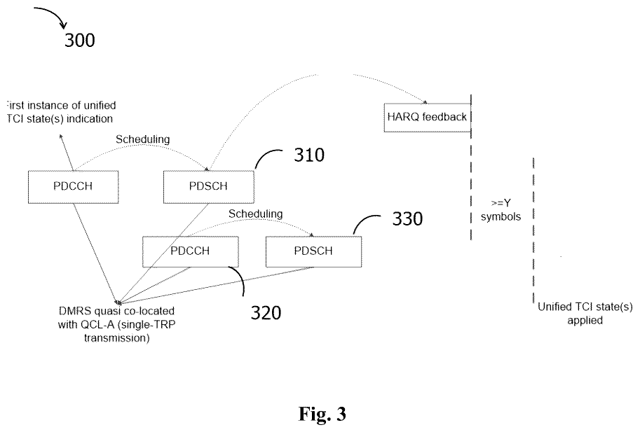

For better understanding, reference is now made to FIG. 3, which illustrates an application timing 300. In the specific example of FIG. 3, channel transmissions (including PDSCH 310, PDCCH 320 and PDSCH 330) are performed based on assuming that a DMRS port of the PDCCH or the PDSCH is quasi co-located with a RS identified during an initial access procedure or a random access procedure. Further, channel transmissions (including PDSCH 310, PDCCH 320 and PDSCH 330) are performed based on the single TRP.

Further, the indicated unified TCI state(s) may be applied according to an application timing. The application timing of the indicated unified TCI state(s) may be considered being completed if at least one indicated unified TCI state has been applied. For example, if there is only one indicated unified TCI state, the terminal device 120 applies the indicated unified TCI state according to application timing. For another example, if there are more than one indicated unified TCI state, the terminal device 120 applies the first one (or a TCI states with the lower/higher ID) of the more than one indicated unified TCI states for the CORESETs.

In some embodiments, if there is only one indicated unified TCI state applied (in a slot) and the terminal device 120 detects a DCI message, a DM-RS antenna port of the PDSCH scheduled by the DCI is performed based on the indicated one unified TCI state, and a single-TRP transmission is assumed/applied for PDSCH scheduled by a DCI before the UE applies an indication of two unified TCI state(s), regardless of where one or two DL/joint unified TCI states are indicated and regardless of whether a single-TRP/multi-TRP transmission mode are indicated in the DCI.

In some embodiments, the two indicated unified TCI states are assumed for PDSCH (as default beam) if the following conditions are satisfied: there are two indicated unified TCI states applied (in a slot), the offset between the reception of the DL DCI and the corresponding PDSCH is less than the threshold timeDurationForQCL and at least one configured TCI state for the serving cell of scheduled PDSCH contains qcl-Type set to ‘typeD. Further, whether and/or which one or two of the TCI states is applied for the PDSCH is determined based on an indication in the DCI (e.g., single/multi-TRP transmission mode indication).

In addition to the above, the multi-TRP based PDSCH transmission may be implemented with introducing a concept of CORESET group. Such example processes will be discussed as below.

In some embodiments, the terminal device 120 receives a first message, where the first message indicates a plurality of CORESETs and each of the plurality of CORESET is associated with one or more CORESET groups.

In some embodiments, for the CORESETs which are configured to apply the indicated TCI state(s), there are two CORESET groups (e.g. a first CORESET group and a second CORESET group. Further, the first TCI state is applied to first CORESET group, and the second TCI state is applied to the second CORESET group.

Next, the terminal device 120 receives at least one second message associated with one or more CORESET groups, where the at least one second message indicates at least one association and each association indicates an association between a CORESET group and at least one TCI state.

According to some embodiments of the present discourse, the terminal device 120 receives a DCI message for scheduling at least one PDSCH, and then the terminal device 120 may receive the at least one PDSCH based on the DCI.

In some embodiments, the DCI message indicates a first indication indicating a number of TCI for the at least one PDSCH.

Alternatively, or in addition, the DCI message indicates a second indication, where the second indication indicates one of multiple TCI states for the at least one PDSCH and the multiple TCI states are being applied for at least one downlink channel.

Alternatively, or in addition, the DCI message indicates a third indication, where the third indication indicates a TCI order for the at least one PDSCH.

In some embodiments, in the TCI field of a DCI, each codepoint is mapped to one DL/joint TCI state, and the one DL/joint TCI state is applied to the corresponding CORESET group after application timing.

In some embodiments, the terminal device 120 may receive a DCI, and the DCI may schedule at least one PDSCH. In some embodiments, there may be a field in the DCI, and the field may indicate a number of TCI states for the at least one PDSCH.

In one specific example embodiment, the bit size for the field may be 1. For example, there may be two possible values in the field (a first value and a second value). The first value may indicate the at least one PDSCH may be based on one TCI state. For example, the TCI state may be applied for the CORESET in which the DCI is received.

Alternatively, in another specific example embodiment, the second value may indicate the at least one PDSCH may be based on two TCI states. For example, one of the two TCI states may be applied for a first CORESET in which the DCI is received. Another one of the two TCI states may be applied for a second CORESET, and the second CORESET may be in a CORESET group which is different from the CORESET group of the first CORESET. For example, the first value may be 0 and the second value may be 1. For another example, the first value may be 1 and the second value may be 0.

In case of single-DCI based multi-TRP transmission, there is a field in the DCI to indicate single-TRP or multi-TRP transmission for the scheduled PDSCH if there is.

In one specific example, the DCI comprises a field of one bit, where value “0”/“1” refers to a single TRP transmission (based on current applied first TCI state) while value “1”/“0” refers to a multi-TRP transmission (based on the current applied first and second TCI states).

In another specific example, the DCI comprises a field of two bits, where four values of the two bits refer to single-TRP (first TCI), multi-TRP (order 1, first TCI, second TCI), multi-TRP (order 2, second TCI, first TCI), single-TRP (second TCI), respectively.

In a further specific example, the DCI comprises a field of three bits, where different values of the three bits refer to single-TRP (first TCI), multi-TRP (order 1, first TCI, second TCI), multi-TRP (order 2, second TCI, first TCI), single-TRP (second TCI) and multi-TRP simultaneous reception, respectively.

In some embodiments, in the TCI field of a DCI, each codepoint is mapped to one or two DL/joint TCI states. In one specific example embodiments, same MAC CE message may be used for codepoint mapping. Further, the first one of DL/joint TCI state is applied to the first CORESE group after application timing while the second one (if two TCI states are indicated in a DCI) is applied to the second CORESET group. Alternatively, in another specific example embodiment, separate MAC CE may be used for codepoint mapping. Specifically, for each CORESET group, the one or the first one of DL/joint TCI state is applied to the CORESET group after application timing, and the second one (if there is) is applied to the other CORESET group after application timing.

In some embodiments, in case of single-DCI based multi-TRP transmission, there is a field in the DCI to indicate single-TRP or multi-TRP transmission for the scheduled PDSCH if there is. In one specific example, the DCI comprises a field of one bit, where value “0”/“1” refers to a single TRP transmission (based on current applied first TCI state) while value “1”/“0” refers to a multi-TRP transmission (based on the current applied first and second TCI states). In another specific example, the DCI comprises a field of two bits, where four values of the two bits refer to Single-TRP (first TCI), multi-TRP (order 1, first TCI, second TCI), multi-TRP (order 2, second TCI, first TCI), single-TRP (second TCI), respectively.

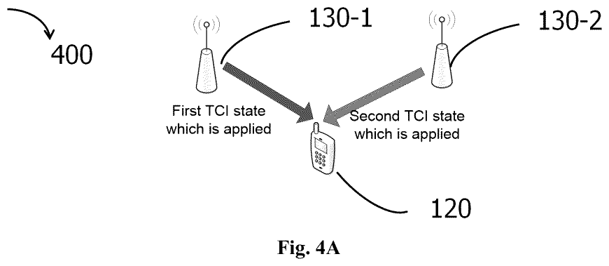

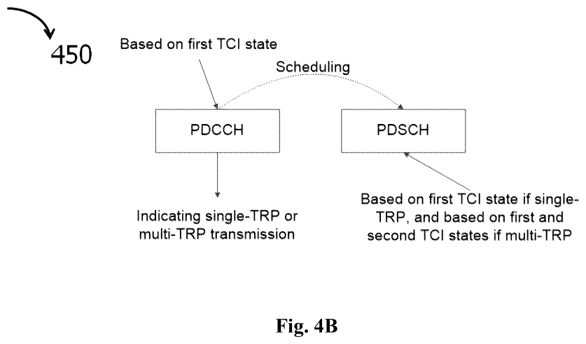

In this way, the single-DCI may indicate whether the single-TRP or multi-TRP PDSCH is applied. For better understanding, reference is now made to FIGS. 4A and 4B, where FIG. 4A illustrates an example scenario 400 in which embodiments of the present disclosure can be implemented and FIG. 4B illustrates an example applying timing 450. As illustrated in FIG. 4A, the terminal device 120 is communicating with the TRPs 130-1 and 130-2 based on the first and second TCI states. As illustrated in FIG. 4B, the terminal device 120 receives a DCI message which indicates a single-TRP or multi-TRP transmission, such as, may be any of the above discussed the first indication, the second indication and the third indication. Then, the following scheduled PDSCH may be performed based on the DCI as discussed above.

### Example Processes for Activating TCI State

In the related solution, the terminal device applies the TCI state(s) after receiving a DC message. Specifically, it is agreed that to support L1-based beam indication using at least UE-specific (unicast) DCI to indicate joint or separate DL/UL beam indication from the active TCI states.

According to some embodiments of the present discourse, the time point for applying the TCI state(s) may be advanced.

Specifically, in some embodiments, the terminal device 120 receives a second message (such as, MAC CE message) indicating at least one mapping from the network device 110, where each mapping indicates a correspondence between a TCI codepoint and at least one TCI state. Then the terminal device 120 applies the at least one TCI state indicated by the second message after an application timing if the at least one TCI state satisfies an application condition.

In some embodiments, the terminal device 120 may determines whether the application condition is satisfied based on one or more parameters. Examples of the one or more parameters are listed as below:
a number of TCI states for downlink transmission supported the terminal device 120,
a number of TCI states for uplink transmission supported the terminal device 120,
a number of TCI states for downlink transmission indicated by the second message,
a number of TCI states for uplink transmission indicated in the second message,
a TCI state for downlink transmission indicated by the second message,
a TCI state for uplink transmission indicated by the second message,
a number of TCI states for a CORESET group and indicated by the second message,
a number of TCI states for an uplink resource set and indicated in the second message,
a number of TCI states for a RS set and indicated in the second message,
a number of CORESET groups configured for the terminal device,
a number of uplink resource sets configured for the terminal device, or
a number of RS sets configured for the terminal device.

It is to be understood that the above examples of the one or more parameters are illustrated only for the purpose of illustration without suggesting any limitations. In other example embodiments, other parameters may be applied. The present disclosure is not limited in this regard.

In some embodiments, the terminal device 120 determines the TCI state satisfies the application condition if one of the following:
the TCI state is an only TCI state for uplink transmission;
the TCI state is an only TCI state for downlink transmission;
the TCI state is an only TCI state for a CORESET group,
the TCI state is an only TCI state for a uplink resource set, or
the TCI state is an only TCI state for a RS set.

It is to be understood that the above example conditions for determining whether the TCI state satisfies the application condition are illustrated only for the purpose of illustration without suggesting any limitations. In other example embodiments, other conditions may be defined. The present disclosure is not limited in this regard.

In some embodiments, if there is only one codepoint (for example, mapping to only one TCI state for downlink and uplink. For another example, mapping to at least one of a TCI state for downlink and a TCI state for uplink) activated by a MAC CE message, the single TCI state is applied after a MAC CE activation timing (such as, 3 ms after HARQ-ACK feedback). In other words, if there is only one codepoint activated by a MAC CE message, there is no need of DCI message indicating the only one TCI state. The terminal device 120 may apply the only one TCI state after the application timing for the MACCE message.

In one specific example embodiment, when the UE (i.e., the terminal device 120) would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where μ is the SCS configuration for the PUCCH.

In some embodiments, if there is only one activated [TCI-State] configured with [tci-StateId_r17] for DL and UL, the one activated [TCI-State] configured with [tci-StateId_r17] should be applied starting from the first slot that is after slot n+3Nₛₗₒₜ^{subframe,μ} where μ is the SCS configuration for the PUCCH (if tci-PresentInDCI is set to ‘enabled’ or tci-PresentDCI-1-2 is configured for the CORESET, the TCI field is ingored).

In some embodiments, if there is only one activated [TCI-State] configured with [tci-StateId_r17] for DL only and/or only one activated [TCI-State] configured with [tci-StateId_r17] for UL only, the activated [TCI-State] s configured with [tci-StateId_r17] should be applied starting from the first slot that is after slot n+3Nₛₗₒₜ^{subframe,μ} where μ is the SCS configuration for the PUCCH (if tci-PresentInDCI is set to ‘enabled’ or tci-PresentDCI-1-2 is configured for the CORESET, the TCI field is ignored).

In some embodiments, if there is only one activated [TCI-State] configured with [tci-StateId_r17] for DL and UL, or if there is only one activated [TCI-State] configured with [tci-StateId_r17] for DL only and/or only one activated [TCI-State] configured with [tci-StateId_r17] for UL only, the activated [TCI-State] configured with [tci-StateId_r17] should be applied starting from the first slot that is after slot n+3Nₛₗₒₜ^{subframe,ρ} where μ is the SCS configuration for the PUCCH.

Additionally, as there is no need of DCI message indicating the only one TCI state, the TCI field in the DCI may be absent.

Specifically, in some embodiments, for DCI format 1_1, the transmission configuration indication (i.e., TCI field) is 0 bit if higher layer parameter tci-PresentInDCI is not enabled or when the number of codepoint in this field is 1.

Specifically, in some embodiments, for DCI format 1_2, the transmission configuration indication (i.e., TCI field) is 0 bit if higher layer parameter tci-PresentDCI-1-2 is not configured or when the number of codepoint S in this field is 1.

In some embodiments, if there is only one or up to one DL/joint TCI state activated for a subset of (M>1) or for all CORESETs (M=1), the activated DL/joint TCI state is applied starting from first slot after MAC CE confirmation.

In some embodiments, if there is only one or up to one UL/joint TCI state activated for a subset of (N>1) or for all PUCCH (N=1), the activated UL/joint TCI state is applied starting from first slot after MAC CE confirmation.

For better understanding, some examples for scenarios of different values of M and N are described in below table 1.

TABLE 1
examples for scenarios of different values of M and N

| Scenarios | Descriptions |
|---|---|
| M = 1, | If MAC CE message actives one joint TCI state or MAC CE |
| N = 1 | message actives one DL TCI state + one UL TCI state, apply the DL |
| | TCI state and the UL TCI state respectively after MAC CE |
| | confirmation (TCI field in the following DCI message can be |
| | ignored, no need of DCI based beam indication) |
| M = 1, | If MAC CE message actives only one DL TCI state (no matter how |
| N > 1 | many codepoints, and in each codepoint, at least UL TCI state can be |
| | different), the DL TCI state is applied after MAC CE confirmation. |
| | and if MAC CE message actives only one or up to one UL |
| | TCI state for each subset of UL channels/RSs, for each subset of |
| | UL channels/RSs, the corresponding UL TCI state is applied |
| | after MAC CE confirmation. TCI field in the following DCI |
| | message can be ignored, no need of DCI based beam indication. |
| | Else if MAC CE message actives more than one UL TCI states |
| | for at least one subset of UL channels/RSs -> DCI is needed to |
| | further indicate UL TCI state(s) to be applied, after beam |
| | application timing. (TCI field in the following DCI message |
| | may be ignored for DL). |
| M > 1, | If MAC CE message actives only one UL TCI state, the UL TCI state |
| N = 1 | is applied after MAC CE confirmation. |
| | and if MAC CE message actives only one or up to one DL |
| | TCI state for each subset of DL channels/RSs, for each subset of |
| | DL channels/RSs, the corresponding DL TCI state is applied |
| | after MAC CE confirmation. (TCI field in the following DCI |
| | message may be ignored, no need of DCI based beam |
| | indication). |
| | Else if MAC CE message actives more than one DL TCI states |
| | for at least one subset of DL channels/RSs -> DCI is needed to |
| | further indicate DL TCI state(s) to be applied, after beam |
| | application timing. (TCI field in the following DCI message |
| | may be ignored for UL). |
| M > 1, | If MAC CE message actives only one DL or up to one TCI state for |
| N > 1 | each subset of DL channels/RSs, the DL TCI state is applied for each |
| | subset after MAC CE confirmation. |
| | and if MAC CE message actives only one or up to one UL |
| | TCI state for each subset of UL channels/RSs, for each subset of |
| | UL channels/RSs, the corresponding UL TCI state is applied |
| | after MAC CE confirmation. (TCI field in the following DCI |
| | message may be ignored, no need of DCI based beam |
| | indication) |
| | Else if MAC actives more than one UL TCI states for at least |
| | one subset of UL channels/RSs -> DCI is needed to further |
| | indicate UL TCI state(s) to be applied, after beam application |
| | timing. (TCI field in the following DCI message may be |
| | ignored for UL). |
| | If MAC CE message actives only one UL or up to one TCI state for |
| | each subset of UL channels/RSs, the UL TCI state is applied for each |
| | subset after MAC CE confirmation. |
| | and if MAC actives only one or up to one DL TCI state for |
| | each subset of DL channels/RSs, for each subset of DL |
| | channels/RSs, the corresponding DL TCI state is applied after |
| | MAC CE confirmation.(TCI field can be ignored, no need of |
| | DCI based beam indication); |
| | Else if MAC CE message actives more than one DL TCI states |
| | for at least one subset of DL channels/RSs -> DCI is needed to |
| | further indicate DL TCI state(s) to be applied, after beam |
| | application timing. (TCI field in the following DCI message |
| | may be ignored for DL). |
| | If MAC CE message actives more than one TCI state for at least one |
| | subset of DL channels/RSs, and if MAC actives more than one UL |
| | TCI states for at least one subset of UL channels/RSs, DCI message |
| | is needed to further indicate DL and/or UL TCI state(s) to be applied, |
| | after beam application timing. |

In some embodiments, for the single-DCI based multi-TRP transmission (i.e., M>1), if there are M CORESET groups, and if there is only one DL or joint TCI state activated by MAC CE for each subset of CORESETs, the DL or joint TCI state should be applied for each subset respectively, starting from the first slot that is after MAC CE confirmation.

Alternatively, in some embodiments, for the single-DCI based multi-TRP transmission (i.e., M>1), if there is only one CORESET group (i.e, all CORESETs or no concept of CORESET group) and if there is only one DL or joint TCI state activated for a subset of DL channels/RSs, the only one of the M TCI state is applied for all CORESETs. For example, the activated TCI states can be applied for each subset respectively after MAC CE confirmation and one of the M TCI state is applied for all CORESETs after MAC CE confirmation. In one specific example embodiments, if the single codepoint maps to two DL or joint TCI states, the first TCI state or TCI state with lower ID is applied for all CORESETs, and single-TRP or multi-TRP transmission is indicated by a field in a DCI. Alternatively, in another example embodiment, if there are more than one codepoint, the lowest codepoint with DL or joint TCI state or the DL or joint TCI state with lower/lowest ID is applied for all CORESETs.

Alternatively, in some embodiments, for the single-DCI based multi-TRP transmission (i.e., M>1), if there is only one subset of CORESETs (i.e, all CORESETs or no concept of CORESET group) and if there is only one DL or joint TCI state activated for a subset of DL channels/RSs, either one of the M TCI state can be further indicated by DCI to be applied for all CORESETs. In one specific example embodiments, the activated TCI states can be applied for each subset of DL channels/RSs (except PDCCH) respectively after MAC CE confirmation. Alternatively, in another example embodiment, for the CORESETs (configured to share the indicated unified TCI state), the one DL TCI state indicated (if only one DL TCI state mapping to the codepoint) or the first one of indicated two DL TCI states (if two DL TCI states mapping to the codepoint) in a DCI is applied after beam application timing.

In some embodiments, the terminal device 120 may transmit HARQ-ACK information in slot n corresponding to at least one of: at least one DCI carrying the TCI state indication and without downlink assignment, and at least one PDSCH scheduling by at least one DCI carrying the TCI state indication, the indicated TCI state may be applied after the application timing. In one specific example embodiment, the indicated TCI state may be different from the previously indicated one. In one specific example embodiment, the HARQ-ACK information may be ACK.

In some embodiments, the HARQ-ACK information may be transmitted in a PUCCH resource. In some embodiments, there may be at least one PUSCH transmission in slot n, and the HARQ-ACK information may be multiplexed in the PUSCH resource. The application timing may be the first slot or the first subslot that is at least Y symbols after the last symbol of the PUSCH resource. For example, Y may be an integer, and 1<=Y<=336. For another example, Y may be one of {7, 14, 28, 224, 336}. In some embodiments, slot may include 12 or 14 symbols. In some embodiments, subslot may include S symbols. S is integer, and 1<=S<=14. For example, S may be one of {2, 4, 7}.

In some embodiments, when a PUCCH resource used for repetitions of a PUCCH transmission by the terminal device 120 includes first and second spatial settings, or first and second sets of power control parameters, and if the terminal device 120 is provided subslotLengthForPUCCH, the terminal device 120 may transmit first and second repetitions of the PUCCH transmission with the UCI consecutively within a slot, and the terminal device 120 may ignore value of N_{PUCCH}^{repeat} if configured, and a number of symbols for each repetition of PUCCH transmission is indicated by subslotLengthForPUCCH, and the terminal device 120 may use the first and second spatial settings, or the first and second sets of power control parameters, for first and second repetitions of the PUCCH transmission, respectively.

In some embodiments, when a PUCCH resource used for repetitions of a PUCCH transmission by the terminal device 120 includes first and second spatial settings, or first and second sets of power control parameters, the terminal device 120
may use the first and second spatial settings, or the first and second sets of power control parameters, for first and second repetitions of the PUCCH transmission, respectively, when N_{PUCCH}^{repeat}=2,
may alternate between the first and second spatial settings, or between the first and second sets of power control parameters, respectively, per N_{PUCCH}^{switch} repetitions of the PUCCH transmission, where N_{PUCCH}^{switch}=1 if mappingPattern=‘cyclicMapping’; else, N_{PUCCH}^{switch}=2,
if the terminal device 120 is provided subslotLengthForPUCCH with value 7 for normal cyclic prefix or value 6 for extended cyclic prefix, N_{PUCCH}^{repeat}=2 regardless the value of PUCCH-nrofSlots or nrofSlots if configured, and if the terminal device 120 is provided subslotLengthForPUCCH with value 2, the terminal device 120 may be expected to be configured with value N_{PUCCH}^{repeat} to be 2 or 4, and the N_{PUCCH}^{repeat} repetitions of the PUCCH transmission are consecutive within a slot.

### Example Methods

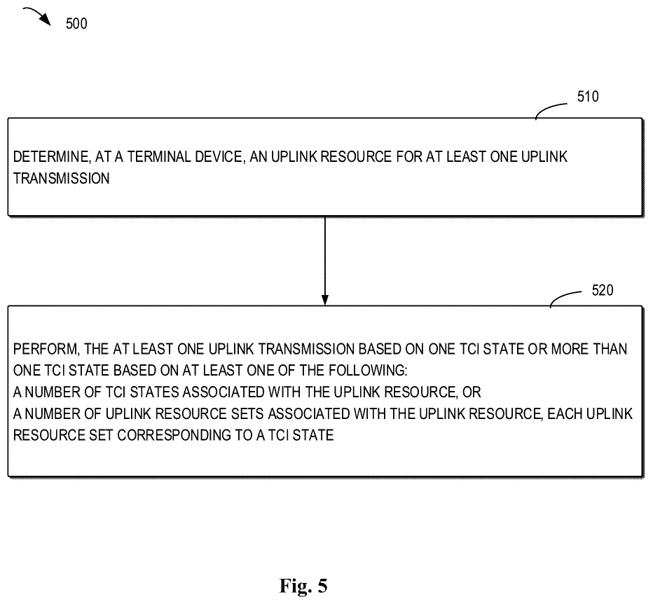

FIG. 5 illustrates a flowchart of an example method 500 in accordance with some embodiments of the present disclosure. For example, the method 500 can be implemented at the terminal device 120 as shown in FIGS. 1A to 1C.

At block 510, the terminal device 120 determines an uplink resource for at least one uplink transmission.

At block 520, the terminal device 120 performs the at least one uplink transmission based on one TCI state or more than one TCI state based on at least one of the following: a number of TCI states associated with the uplink resource, or a number of uplink resource sets associated with the uplink resource, each uplink resource set corresponding to a TCI state.

In some embodiments, the terminal device 120 performs the at least one uplink transmission comprises at least one of the following: performing the at least one uplink transmission based on one TCI state if the uplink resource is associated with the one TCI state or one uplink resource set; or performing the at least one uplink transmission based on more than one TCI states if the uplink resource is associated with the more than one TCI state or more than one uplink resource set.

In some embodiments, the terminal device 120 performs the at least one uplink transmission based on more than one TCI states comprises at least one of the following: if a repetition parameter configured for the at least one uplink transmission is larger than one, performing the uplink transmission based on the more than one TCI state with more than one transmission occasion, each transmission occasion being associated with one of the more than one TCI state; or if a repetition parameter configured for the at least one uplink transmission is absent or equals to one, performing the uplink transmission based on the more than one TCI state.

In some embodiments, the terminal device 120 performs the uplink transmission comprises at least one of the following: if the uplink resource is associated with more than two TCI states, performing the at least one uplink transmission based on two TCI states determined from the more than two TCI states; or if the uplink resource is associated with more than two uplink resource sets, performing the at least one uplink transmission based on two uplink resource sets determined from the more than two uplink resource sets.

In some embodiments, the two TCI states are one of the following: two TCI states with lower identifies, two TCI states with higher identifies, two latest-used TCI states, or two TCI states determined either by the terminal device 120 or a network device 110.

In some embodiments, the two uplink resource sets are one of the following: two uplink resource sets with lower identifies, two uplink resource sets with higher identifies, two latest-used uplink resource sets, or two uplink resource sets determined either by the terminal device 120 or a network device 110.

In some embodiments, the terminal device 120 receives, from a network device 110, a first message indicating: at least one uplink resource, each of the at least one uplink resource associated with one or more uplink resource sets; and a plurality of TCI states.

In some embodiments, the terminal device 120 receives, from the network device 110, a second message indicating: at least one association, each of the at least one association indicating an association between an uplink resource set and at least one TCI state.

In some embodiments, the terminal device 120 performs the uplink transmission based on at least one of the following: at least one currently-used TCI state, TCI states associated with the uplink resource, one or more TCI states to be used the terminal device 120, indicated by at least one DCI message, or at least one spatial domain filter used for a PUSCH, wherein the PUSCH is at least one of: a PUSCH scheduled by a RAR uplink grant, a MsgA PUSCH or a PUSCH scheduled during an initial access procedure.

In some embodiments, the terminal device 120 performs the uplink transmission based on more than one TCI state if at least one of the more than one TCI state associated with the uplink resource is indicated and applied after an application timing.

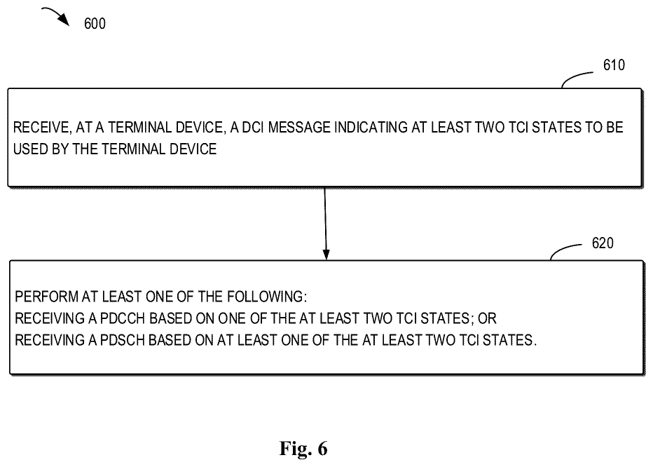

FIG. 6 illustrates a flowchart of an example method 600 in accordance with some embodiments of the present disclosure. For example, the method 600 can be implemented at the terminal device 120 as shown in FIGS. 1A to 1C.

At block 610, the terminal device 120 receives a DCI message indicating at least two TCI states to be used by the terminal device 120.

At block 620, the terminal device 120 performs at least one of the following: receiving a PDCCH based on one of the at least two TCI states; or receiving a PDSCH based on at least one of the at least two TCI states.

In some embodiments, prior to applying the at least two indicated TCI states, the terminal device 120 receives the PDCCH or PDSCH based on at least one of the following: assuming that a DMRS port of the PDCCH or the PDSCH is quasi co-located with a RS identified during an initial access procedure or a random access procedure, or one applied TCI state.

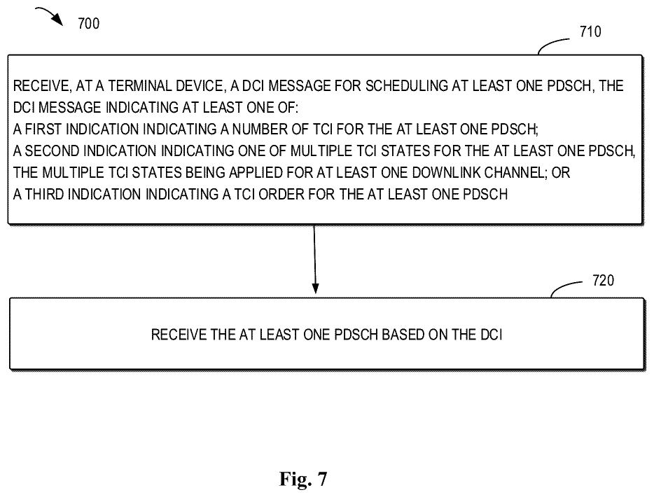

FIG. 7 illustrates a flowchart of an example method 700 in accordance with some embodiments of the present disclosure. For example, the method 700 can be implemented at the terminal device 120 as shown in FIGS. 1A to 1C.

At block 710, the terminal device 120 receives a DCI for scheduling at least one PDSCH, the DCI message indicating at least one of: a first indication indicating a number of TCI for the at least one PDSCH; a second indication indicating one of multiple TCI states for the at least one PDSCH, the multiple TCI states being applied for at least one downlink channel; or a third indication indicating a TCI order for the at least one PDSCH.

At block 720, the terminal device 120 receives the at least one PDSCH based on the DCI.

In some embodiments, the terminal device 120 receives, from the network device 110, a first message indicating: a plurality of CORESETs, each of plurality of CORESET associated with a CORESET group.

In some embodiments, the terminal device 120 receives, from the network device 110, at least one second message associated with one or more CORESET groups, the at least one second message indicating: at least one association, each association indicating an association between a CORESET group and at least one TCI state.

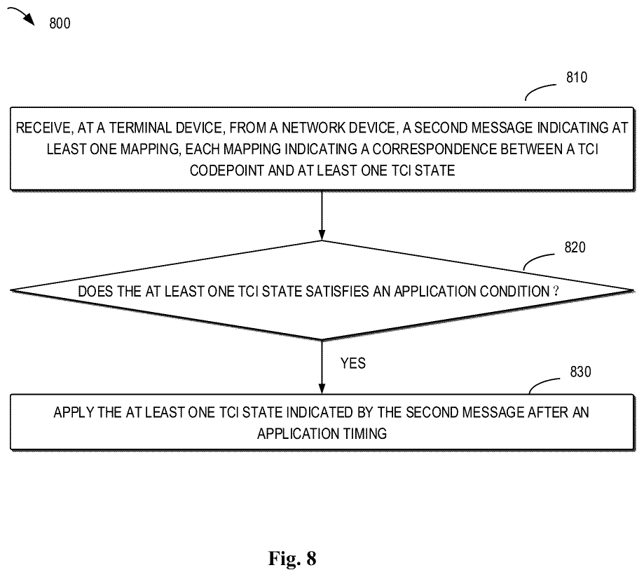

FIG. 8 illustrates a flowchart of an example method 800 in accordance with some embodiments of the present disclosure. For example, the method 800 can be implemented at the terminal device 120 as shown in FIGS. 1A to 1C.

At block 810, the terminal device 120 receives, at a terminal device 120, from a network device 110, a second message indicating at least one mapping, each mapping indicating a correspondence between a TCI codepoint and at least one TCI state.

At block 820, the terminal device 120 determines whether the at least one TCI state satisfies an application condition.

At block 830, the terminal device 120 applies the at least one TCI state indicated by the second message after an application timing if the at least one TCI state satisfies an application condition.

In some embodiments, the terminal device 120 determines whether the application condition is satisfied based on at least one of the following: a number of TCI states for downlink transmission supported by the terminal device 120, a number of TCI states for uplink transmission supported by the terminal device 120, a number of TCI states for downlink transmission indicated by the second message, a number of TCI states for uplink transmission indicated in the second message, a TCI state for downlink transmission indicated by the second message, a TCI state for uplink transmission indicated by the second message, a number of TCI states for a CORESET group and indicated by the second message, a number of TCI states for an uplink resource set and indicated in the second message, a number of TCI states for a RS set and indicated in the second message, a number of CORESET groups configured for the terminal device 120, a number of uplink resource sets configured for the terminal device 120, or a number of RS sets configured for the terminal device 120.

In some embodiments, the terminal device 120 determines the TCI state satisfies the application condition if one of the following: the TCI state is an only TCI state for uplink transmission, the TCI state is an only TCI state for downlink transmission; the TCI state is an only TCI state for a CORESET group, the TCI state is an only TCI state for a uplink resource set, or the TCI state is an only TCI state for a RS set.

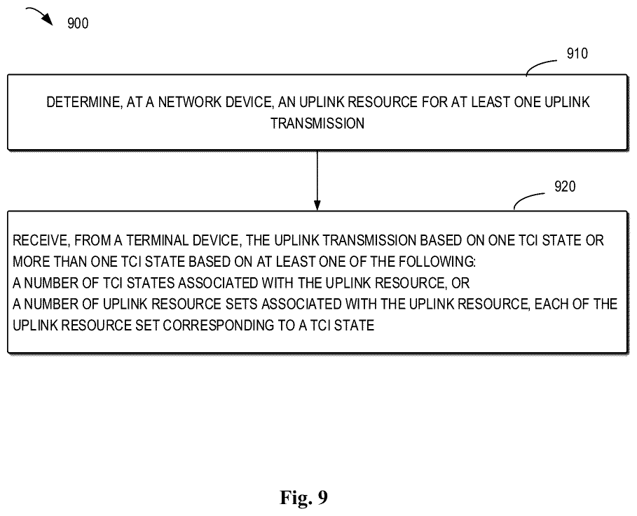

FIG. 9 illustrates a flowchart of an example method 900 in accordance with some embodiments of the present disclosure. For example, the method 900 can be implemented at the network device 110 as shown in FIGS. 1A to 1C.

At block 910, the network device 110 determines an uplink resource for at least one uplink transmission.

At block 920, the network device 110 receives, from a terminal device 120, the uplink transmission based on one TCI state or more than one TCI state based on at least one of the following: a number of TCI states associated with the uplink resource, or a number of uplink resource sets associated with the uplink resource, each of the uplink resource set corresponding to a TCI state.

In some embodiments, the network device 110 receives the at least one uplink transmission comprises at least one of the following: receiving the at least one uplink transmission based on one TCI state if the uplink resource is associated with the one TCI state or one uplink resource set; or receiving the at least one uplink transmission based on more than one TCI states if the uplink resource is associated with the more than one TCI state or more than one uplink resource set.

In some embodiments, the network device 110 receives the at least one uplink transmission based on more than one TCI state comprises at least one of the following: if a repetition parameter configured for the at least one uplink transmission is larger than one, receiving the at least one uplink transmission based on the more than one TCI state with more than one transmission occasion, each transmission occasion being associated with one of the more than one TCI state; or if a repetition parameter configured for the at least one uplink transmission is absent or equals to one, receiving the at least one uplink transmission based on the more than one TCI state.

In some embodiments, the network device 110 receives the at least one uplink transmission comprises at least one of the following: if the uplink resource is associated with more than two TCI states, performing the at least one uplink transmission based on two TCI states determined from the more than two TCI states; or if the uplink resource is associated with more than two uplink resource sets, receiving the uplink transmission based on two uplink resource sets determined from the more than two uplink resource sets.

In some embodiments, the two TCI states are one of the following: two TCI states with lower identifies, two TCI states with higher identifies, two latest-used TCI states, or two TCI states determined either by the terminal device 120 or a network device 110.

In some embodiments, the two uplink resource sets are one of the following: two uplink resource sets with lower identifies, two uplink resource sets with higher identifies, two latest-used uplink resource sets, or two uplink resource sets determined either by the terminal device 120 or a network device 110.

In some embodiments, the network device 110 transmits, to the terminal device 120, a first message indicating: at least one uplink resource, each of the at least one uplink resource associated with one or more uplink resource sets; and a plurality of TCI states.

In some embodiments, the network device 110 transmits, to the terminal device 120, a second message indicating: at least one association, each of the at least one association indicating an association between an uplink resource set and at least one TCI state.

In some embodiments, the network device 110 receives the uplink transmission based on at least one of the following: at least one currently-used TCI state, TCI states associated with the uplink resource, one or more TCI states to be used the terminal device 120, indicated by at least one DCI message, or at least one spatial domain filter used for a PUSCH, wherein the PUSCH is at least one of: a PUSCH scheduled by a RAR uplink grant, a MsgA PUSCH or a PUSCH scheduled during an initial access procedure.

In some embodiments, the network device 110 receives the uplink transmission based on more than one TCI state if at least one of the more than one TCI state associated with the uplink resource is indicated and applied after an application timing.

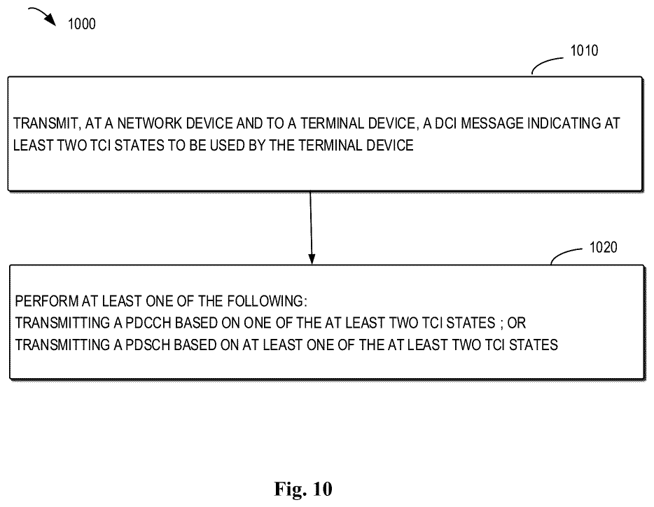

FIG. 10 illustrates a flowchart of an example method 1000 in accordance with some embodiments of the present disclosure. For example, the method 1000 can be implemented at the network device 110 as shown in FIGS. 1A to 1C.

At block 1010, the network device 110 transmits, to a terminal device 120, a DCI message indicating at least two TCI states to be used by the terminal device 120.

At block 1020, the network device 110 performs at least one of the following: transmitting a PDCCH based on one of the at least two TCI states; or transmitting a PDSCH based on at least one of the at least two TCI states.

In some embodiments, prior to applying the at least two indicated TCI states, the network device 110 transmits the PDCCH or PDSCH based on at least one of the following: a DMRS port of the PDCCH or the PDSCH transmission being quasi co-located with a RS identified during an initial access procedure or a random access procedure, or one applied TCI state.

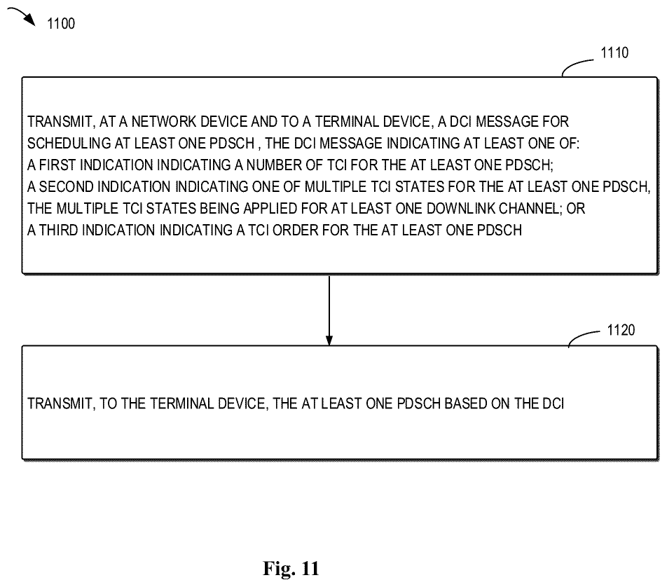

FIG. 11 illustrates a flowchart of an example method 1100 in accordance with some embodiments of the present disclosure. For example, the method 1100 can be implemented at the network device 110 as shown in FIGS. 1A to 1C.

At block 1110, the network device 110 transmits, at network device 110 and to a terminal device 120, a DCI message for scheduling at least one PDSCH, the DCI message indicating at least one of: a first indication indicating a number of TCI for the at least one PDSCH; a second indication indicating one of multiple TCI states for the at least one PDSCH, the multiple TCI states being applied for at least one downlink channel; and a third indication indicating a TCI order for the at least one PDSCH.

At block 1120, the network device 110 transmits, to the terminal device 120, the at least one PDSCH based on the DCI.

In some embodiments, the network device 110 transmits, to the terminal device 120, a first message indicating: a plurality of CORESETs, each of plurality of CORESET associated with a CORESET group.

In some embodiments, the network device 110 transmits, to the terminal device 120, at least one second message associated with one or more CORESET groups, the at least one second message indicating: at least one association, each association indicating an association between a CORESET group and at least one TCI state.

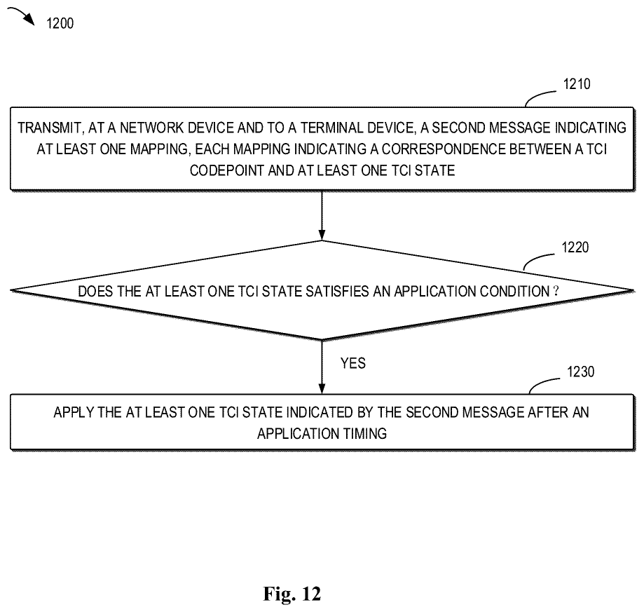

FIG. 12 illustrates a flowchart of an example method 1200 in accordance with some embodiments of the present disclosure. For example, the method 1200 can be implemented at the network device 110 as shown in FIGS. 1A to 1C.

At block 1210, the network device 110 transmits, to a terminal device 120, a second message indicating at least one mapping, each mapping indicating a correspondence between a TCI codepoint and at least one TCI state.

At block 1220, the network device 110 determines whether the TCI state satisfies an application condition.

At block 1230, the network device 110 applies the at least one TCI state indicated by the second message after an application timing if the TCI state satisfies an application condition.

In some embodiments, the network device 110 determines whether the application condition is satisfied based on at least one of the following: a number of TCI states for downlink transmission supported by the terminal device 120, a number of TCI states for uplink transmission supported by the terminal device 120, a number of TCI states for downlink transmission indicated by the second message, a number of TCI states for uplink transmission indicated in the second message, one TCI state for downlink transmission indicated by the second message, one TCI state for uplink transmission indicated by the second message, a number of TCI states for a CORESET group and indicated by the second message, a number of TCI states for an uplink resource set and indicated in the second message, a number of TCI states for a RS set and indicated in the second message, a number of CORESET groups configured for the terminal device 120, a number of uplink resource sets configured for the terminal device 120, or a number of RS sets configured for the terminal device 120.

In some embodiments, the network device 110 determines the TCI state satisfies the application condition if one of the following: the TCI state is an only TCI state for uplink transmission; the TCI state is an only TCI state for downlink transmission; the TCI state is an only TCI state for a CORESET group; the TCI state is an only TCI state for a uplink resource set; or the TCI state is an only TCI state for a RS set.

### Example Devices

In some example embodiments, the terminal device 120 comprises circuitry configured to: determine an uplink resource for at least one uplink transmission; and perform the at least one uplink transmission based on one TCI state or more than one TCI state based on at least one of the following: a number of TCI states associated with the uplink resource, or a number of uplink resource sets associated with the uplink resource, each uplink resource set corresponding to a TCI state.

In some embodiments, the terminal device 120 performs the at least one uplink transmission comprises at least one of the following: performing the at least one uplink transmission based on one TCI state if the uplink resource is associated with the one TCI state or one uplink resource set; or performing the at least one uplink transmission based on more than one TCI states if the uplink resource is associated with the more than one TCI state or more than one uplink resource set.

In some embodiments, the circuitry is further configured to: perform the at least one uplink transmission based on more than one TCI states comprises at least one of the following: if a repetition parameter configured for the at least one uplink transmission is larger than one, performing the uplink transmission based on the more than one TCI state with more than one transmission occasion, each transmission occasion being associated with one of the more than one TCI state; or if a repetition parameter configured for the at least one uplink transmission is absent or equals to one, performing the uplink transmission based on the more than one TCI state.

In some embodiments, the circuitry is further configured to; perform the uplink transmission comprises at least one of the following: if the uplink resource is associated with more than two TCI states, performing the at least one uplink transmission based on two TCI states determined from the more than two TCI states; or if the uplink resource is associated with more than two uplink resource sets, performing the at least one uplink transmission based on two uplink resource sets determined from the more than two uplink resource sets.

In some embodiments, the two TCI states are one of the following: two TCI states with lower identifies, two TCI states with higher identifies, two latest-used TCI states, or two TCI states determined either by the terminal device 120 or a network device 110.

In some embodiments, the two uplink resource sets are one of the following: two uplink resource sets with lower identifies, two uplink resource sets with higher identifies, two latest-used uplink resource sets, or two uplink resource sets determined either by the terminal device 120 or a network device 110.

In some embodiments, the circuitry is further configured to: receive, from a network device 110, a first message indicating: at least one uplink resource, each of the at least one uplink resource associated with one or more uplink resource sets; and a plurality of TCI states.

In some embodiments, the circuitry is further configured to: receive, from the network device 110, a second message indicating: at least one association, each of the at least one association indicating an association between an uplink resource set and at least one TCI state.

In some embodiments, the circuitry is further configured to: perform the uplink transmission based on at least one of the following: at least one currently-used TCI state, TCI states associated with the uplink resource, one or more TCI states to be used the terminal device 120, indicated by at least one DCI message, or at least one spatial domain filter used for a PUSCH, wherein the PUSCH is at least one of: a PUSCH scheduled by a RAR uplink grant, a MsgA PUSCH or a PUSCH scheduled during an initial access procedure.

In some embodiments, the circuitry is further configured to: perform the uplink transmission based on more than one TCI state if at least one of the more than one TCI state associated with the uplink resource is indicated and applied after an application timing.

In some example embodiments, the terminal device 120 comprises circuitry configured to: receive a DCI message indicating at least two TCI states to be used by the terminal device 120; and perform at least one of the following: receiving a PDCCH based on one of the at least two TCI states; or receiving a PDSCH based on at least one of the at least two TCI states.

In some embodiments, the circuitry is further configured to: prior to applying the at least two indicated TCI states, receive the PDCCH or PDSCH based on at least one of the following: assuming that a DMRS port of the PDCCH or the PDSCH is quasi co-located with a RS identified during an initial access procedure or a random access procedure, or one applied TCI state.

In some example embodiments, the terminal device 120 comprises circuitry configured to: receive a DCI for scheduling at least one PDSCH, the DCI message indicating at least one of: a first indication indicating a number of TCI for the at least one PDSCH; a second indication indicating one of multiple TCI states for the at least one PDSCH, the multiple TCI states being applied for at least one downlink channel; or a third indication indicating a TCI order for the at least one PDSCH; and receive the at least one PDSCH based on the DCI.

In some embodiments, the circuitry is further configured to: receive, from the network device 110, a first message indicating: a plurality of CORESETs, each of plurality of CORESET associated with a CORESET group.

In some embodiments, the circuitry is further configured to: receive, from the network device 110, at least one second message associated with one or more CORESET groups, the at least one second message indicating: at least one association, each association indicating an association between a CORESET group and at least one TCI state.

In some example embodiments, the terminal device 120 comprises circuitry configured to: receive, at a terminal device 120, from a network device 110, a second message indicating at least one mapping, each mapping indicating a correspondence between a TCI codepoint and at least one TCI state; determine whether the at least one TCI state satisfies an application condition; and apply the at least one TCI state indicated by the second message after an application timing if the at least one TCI state satisfies an application condition.

In some embodiments, the circuitry is further configured to: determine whether the application condition is satisfied based on at least one of the following: a number of TCI states for downlink transmission supported by the terminal device 120, a number of TCI states for uplink transmission supported by the terminal device 120, a number of TCI states for downlink transmission indicated by the second message, a number of TCI states for uplink transmission indicated in the second message, a TCI state for downlink transmission indicated by the second message, a TCI state for uplink transmission indicated by the second message, a number of TCI states for a CORESET group and indicated by the second message, a number of TCI states for an uplink resource set and indicated in the second message, a number of TCI states for a RS set and indicated in the second message, a number of CORESET groups configured for the terminal device 120, a number of uplink resource sets configured for the terminal device 120, or a number of RS sets configured for the terminal device 120.

In some embodiments, the circuitry is further configured to: determine the TCI state satisfies the application condition if one of the following: the TCI state is an only TCI state for uplink transmission, the TCI state is an only TCI state for downlink transmission; the TCI state is an only TCI state for a CORESET group, the TCI state is an only TCI state for a uplink resource set, or the TCI state is an only TCI state for a RS set.

In some example embodiments, the network device 110 comprises circuitry configured to: determine an uplink resource for at least one uplink transmission; and receive, from a terminal device 120, the uplink transmission based on one TCI state or more than one TCI state based on at least one of the following: a number of TCI states associated with the uplink resource, or a number of uplink resource sets associated with the uplink resource, each of the uplink resource set corresponding to a TCI state.

In some embodiments, the circuitry is further configured to: receive the at least one uplink transmission comprises at least one of the following: receiving the at least one uplink transmission based on one TCI state if the uplink resource is associated with the one TCI state or one uplink resource set; or receiving the at least one uplink transmission based on more than one TCI states if the uplink resource is associated with the more than one TCI state or more than one uplink resource set.

In some embodiments, the circuitry is further configured to: receive the at least one uplink transmission based on more than one TCI state comprises at least one of the following: if a repetition parameter configured for the at least one uplink transmission is larger than one, receiving the at least one uplink transmission based on the more than one TCI state with more than one transmission occasion, each transmission occasion being associated with one of the more than one TCI state; or if a repetition parameter configured for the at least one uplink transmission is absent or equals to one, receiving the at least one uplink transmission based on the more than one TCI state.

In some embodiments, the circuitry is further configured to: receive the at least one uplink transmission comprises at least one of the following: if the uplink resource is associated with more than two TCI states, performing the at least one uplink transmission based on two TCI states determined from the more than two TCI states; or if the uplink resource is associated with more than two uplink resource sets, receiving the uplink transmission based on two uplink resource sets determined from the more than two uplink resource sets.

In some embodiments, the two TCI states are one of the following: two TCI states with lower identifies, two TCI states with higher identifies, two latest-used TCI states, or two TCI states determined either by the terminal device 120 or a network device 110.

In some embodiments, the two uplink resource sets are one of the following: two uplink resource sets with lower identifies, two uplink resource sets with higher identifies, two latest-used uplink resource sets, or two uplink resource sets determined either by the terminal device 120 or a network device 110.

In some embodiments, the circuitry is further configured to: transmit, to the terminal device 120, a first message indicating: at least one uplink resource, each of the at least one uplink resource associated with one or more uplink resource sets; and a plurality of TCI states.

In some embodiments, the circuitry is further configured to: transmit, to the terminal device 120, a second message indicating: at least one association, each of the at least one association indicating an association between an uplink resource set and at least one TCI state.

In some embodiments, the circuitry is further configured to: receive, the uplink transmission based on at least one of the following: at least one currently-used TCI state, TCI states associated with the uplink resource, one or more TCI states to be used the terminal device 120, indicated by at least one DCI message, or at least one spatial domain filter used for a PUSCH, wherein the PUSCH is at least one of: a PUSCH scheduled by a RAR uplink grant, a MsgA PUSCH or a PUSCH scheduled during an initial access procedure.

In some embodiments, the circuitry is further configured to: receive the uplink transmission based on more than one TCI state if at least one of the more than one TCI state associated with the uplink resource is indicated and applied after an application timing.

In some example embodiments, the network device 110 comprises circuitry configured to: transmit, to a terminal device 120, a DCI message indicating at least two TCI states to be used by the terminal device 120; and perform at least one of the following: transmitting a PDCCH based on one of the at least two TCI states; or transmitting a PDSCH based on at least one of the at least two TCI states.

In some embodiments, the circuitry is further configured to: prior to applying the at least two indicated TCI states, transmit the PDCCH or PDSCH based on at least one of the following: a DMRS port of the PDCCH or the PDSCH transmission being quasi co-located with a RS identified during an initial access procedure or a random access procedure, or one applied TCI state.

In some example embodiments, the network device 110 comprises circuitry configured to: transmit, at network device 110 and to a terminal device 120, a DCI for scheduling at least one PDSCH, the DCI message indicating at least one of: a first indication indicating a number of TCI for the at least one PDSCH; a second indication indicating one of multiple TCI states for the at least one PDSCH, the multiple TCI states being applied for at least one downlink channel; and a third indication indicating a TCI order for the at least one PDSCH; and transmit, to the terminal device 120, the at least one PDSCH based on the DCI.

In some embodiments, the circuitry is further configured to: transmit, to the terminal device 120, a first message indicating: a plurality of CORESETs, each of plurality of CORESET associated with a CORESET group.

In some embodiments, the circuitry is further configured to: transmit, to the terminal device 120, at least one second message associated with one or more CORESET groups, the at least one second message indicating: at least one association, each association indicating an association between a CORESET group and at least one TCI state.

In some example embodiments, the network device 110 comprises circuitry configured to: transmit, to a terminal device 120, a second message indicating at least one mapping, each mapping indicating a correspondence between a TCI codepoint and at least one TCI state; determine whether the TCI state satisfies an application condition; and 0 apply the at least one TCI state indicated by the second message after an application timing if the TCI state satisfies an application condition.

In some embodiments, the circuitry is further configured to: determine whether the application condition is satisfied based on at least one of the following: a number of TCI states for downlink transmission supported by the terminal device 120, a number of TCI states for uplink transmission supported by the terminal device 120, a number of TCI states for downlink transmission indicated by the second message, a number of TCI states for uplink transmission indicated in the second message, one TCI state for downlink transmission indicated by the second message, one TCI state for uplink transmission indicated by the second message, a number of TCI states for a CORESET group and indicated by the second message, a number of TCI states for an uplink resource set and indicated in the second message, a number of TCI states for a RS set and indicated in the second message, a number of CORESET groups configured for the terminal device 120, a number of uplink resource sets configured for the terminal device 120, or a number of RS sets configured for the terminal device 120.

In some embodiments, the circuitry is further configured to: determine the TCI state satisfies the application condition if one of the following: the TCI state is an only TCI state for uplink transmission; the TCI state is an only TCI state for downlink transmission; the TCI state is an only TCI state for a CORESET group; the TCI state is an only TCI state for a uplink resource set; or the TCI state is an only TCI state for a RS set.

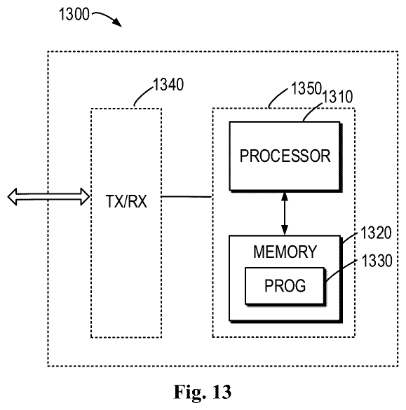

FIG. 13 is a simplified block diagram of a device 1300 that is suitable for implementing embodiments of the present disclosure. The device 1300 can be considered as a further example implementation of the terminal 120 and the network devices 110-1 and 110-2 as shown in FIGS. 1A to 1C. Accordingly, the device 1300 can be implemented at or as at least a part of the terminal 120 and the network devices 110-1 and 110-2.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the CNB and a relay node (RN), or Uu interface for communication between the eNB and a terminal device.

The program 1330 is assumed to include program instructions that, when executed by the associated processor 1310, enable the device 1300 to operate in accordance with the embodiments of the present disclosure, as discussed herein with reference to FIGS. 2-12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-39. (canceled)

40. A method of communication performed by a terminal device, the method comprising:
receiving, from a network device, a downlink control information (DCI), for scheduling at least one physical downlink shared channel (PDSCH), comprising a first field and a second field, wherein the first field indicates at least one transmission configuration indication (TCI) state, and the second field indicates that a first one of two TCI states, a second one of the two TCI states or both of the two TCI states are applied to the at least one PDSCH in a case where the two TCI states are indicated in the first field; and
receiving, from the network device, the at least one PDSCH based on the DCI.

41. The method of claim 40, wherein the at least one TCI state is applied from a first slot which is Y symbols after a last symbol of a positive hybrid automatic repeat request acknowledgement (HARQ-ACK) corresponding to the first DCI, Y is an integer.

42. The method of claim 40, further comprising:
receiving, from the network device, a medium access control (MAC) control element (CE) message, wherein the MAC CE message is used to map at least one set of TCI states to at least one TCI codepoint; and
applying the at least one set of TCI states in a case where the MAC CE message is used to map one set of TCI states to one TCI codepoint.

43. The method of claim 40, further comprising:
receiving, from the network device, a configuration of a control resource set (CORESET), wherein the configuration indicates which one of the two TCI states is applied for the CORESET.

44. A method of communication performed by a terminal device, the method comprising:
receiving, from a network device, a downlink control information (DCI), for scheduling at least one physical downlink shared channel (PDSCH), comprising a first field indicating that a first one of two transmission configuration indication (TCI) states, a second one of the two TCI states or both of the two TCI states are applied to the at least one PDSCH in a case where the two TCI states are indicated to the terminal device; and
receiving, from the network device, the at least one PDSCH based on the DCI.

45. A method of communication performed by a network device, the method comprising:
transmitting, to a terminal device, a downlink control information (DCI), for scheduling at least one physical downlink shared channel (PDSCH), comprising a first field and a second field, wherein the first field indicates at least one transmission configuration indication (TCI) state, and the second field indicates that a first one of two TCI states, a second one of the two TCI states or both of the two TCI states are applied to the at least one PDSCH in a case where the two TCI states are indicated in the first field; and
transmitting, to the terminal device, the at least one PDSCH based on the DCI.

46. The method of claim 45, wherein the at least one TCI state is applied from a first slot which is Y symbols after a last symbol of a positive hybrid automatic repeat request acknowledgement (HARQ-ACK) corresponding to the first DCI, Y is an integer.

47. The method of claim 45, further comprising:
transmitting, to the terminal device, a medium access control (MAC) control element (CE) message, wherein the MAC CE message is used to map at least one set of TCI states to at least one TCI codepoint, wherein the at least one set of TCI states is applied in a case where the MAC CE message is used to map one set of TCI states to one TCI codepoint.

48. The method of claim 45, further comprising:
transmitting, to the terminal device, a configuration of a control resource set (CORESET), wherein the configuration indicates which one of the two TCI states is applied for the CORESET.

49. A method of communication performed by a network device, the method comprising:
transmitting, to a terminal device, a downlink control information (DCI), for scheduling at least one physical downlink shared channel (PDSCH), comprising a first field indicating that a first one of two transmission configuration indication (TCI) states, a second one of the two TCI states or both of the two TCI states are applied to the at least one PDSCH in a case where the two TCI states are indicated to the terminal device; and
transmitting, to the terminal device, the at least one PDSCH based on the DCI.

50. A terminal device comprising a processor configured to cause the terminal device to:
receive, from a network device, a downlink control information (DCI), for scheduling at least one physical downlink shared channel (PDSCH), comprising a first field and a second field, wherein the first field indicates at least one transmission configuration indication (TCI) state, and the second field indicates that a first one of two TCI states, a second one of the two TCI states or both of the two TCI states are applied to the at least one PDSCH in a case where the two TCI states are indicated in the first field; and
receive, from the network device, the at least one PDSCH based on the DCI.

51. The terminal device of claim 50, wherein the at least one TCI state is applied from a first slot which is Y symbols after a last symbol of a positive hybrid automatic repeat request acknowledgement (HARQ-ACK) corresponding to the first DCI, Y is an integer.

52. The terminal device of claim 50, the processor is further configured to cause the terminal device to:
receive, from the network device, a medium access control (MAC) control element (CE) message, wherein the MAC CE message is used to map at least one set of TCI states to at least one TCI codepoint; and
apply the at least one set of TCI states in a case where the MAC CE message is used to map one set of TCI states to one TCI codepoint.

53. The terminal device of claim 50, the processor is further configured to cause the terminal device to:
receive, from the network device, a configuration of a control resource set (CORESET), wherein the configuration indicates which one of the two TCI states is applied for the CORESET.

54. A terminal device comprising a processor configured to cause the terminal device to:
receive, from a network device, a downlink control information (DCI), for scheduling at least one physical downlink shared channel (PDSCH), comprising a first field indicating that a first one of two transmission configuration indication (TCI) states, a second one of the two TCI states or both of the two TCI states are applied to the at least one PDSCH in a case where the two TCI states are indicated to the terminal device; and
receive, from the network device, the at least one PDSCH based on the DCI.

55. A network device comprising a processor configured to cause the network device to:
transmit, to a terminal device, a downlink control information (DCI), for scheduling at least one physical downlink shared channel (PDSCH), comprising a first field and a second field, wherein the first field indicates at least one transmission configuration indication (TCI) state, and the second field indicates that a first one of two TCI states, a second one of the two TCI states or both of the two TCI states are applied to the at least one PDSCH in a case where the two TCI states are indicated in the first field; and
transmit, to the terminal device, the at least one PDSCH based on the DCI.

56. The network device of claim 55, wherein the at least one TCI state is applied from a first slot which is Y symbols after a last symbol of a positive hybrid automatic repeat request acknowledgement (HARQ-ACK) corresponding to the first DCI, Y is an integer.

57. The network device of claim 55, the processor is further configured to cause the network device to:
transmit, to the terminal device, a medium access control (MAC) control element (CE) message, wherein the MAC CE message is used to map at least one set of TCI states to at least one TCI codepoint, wherein the at least one set of TCI states is applied in a case where the MAC CE message is used to map one set of TCI states to one TCI codepoint.

58. The network device of claim 55, the processor is further configured to cause the network device to:
transmit, to the terminal device, a configuration of a control resource set (CORESET), wherein the configuration indicates which one of the two TCI states is applied for the CORESET.

59. A network device comprising a processor configured to cause the network device to:
transmit, to a terminal device, a downlink control information (DCI), for scheduling at least one physical downlink shared channel (PDSCH), comprising a first field indicating that a first one of two transmission configuration indication (TCI) states, a second one of the two TCI states or both of the two TCI states are applied to the at least one PDSCH in a case where the two TCI states are indicated to the terminal device; and
transmit, to the terminal device, the at least one PDSCH based on the DCI.
